(19) United States
(12) Patent Application Publication
(10) Pub. No.: US 2019/0012630 A1
(43) Pub. Date: Jan. 10, 2019

(54) ENTITY SAFETY RATING SYSTEM

(71) Applicant: TYFOOM, LLC, Springville, UT (US)

(72) Inventors: N. Ryan Moss, Mapleton, UT (US); Amber Beckstrom, Fort Collins, CO (US); Mark L. Nelson, Mapleton, UT (US)

(73) Assignee: TYFOOM, LLC, Springville, UT (US)

(21) Appl. No.: 16/028,182

(22) Filed: Jul. 5, 2018

Related U.S. Application Data
(60) Provisional application No. 62/528,885, filed on Jul. 5, 2017.
(60) Provisional application No. 62/613,922, filed on Jan. 5, 2018.

(51) Int. Cl. G06Q 10/06; G06Q 10/10; G09B 19/00

(52) U.S. Cl. CPC G06Q 10/063114; G09B 19/00; G06Q 10/06398; G06Q 10/105

(57) ABSTRACT

A method for improving safety and/or training compliance computer systems is described. In one embodiment, the method includes generating a safety rating of an entity, generating a safety rating of a person associated with the entity, detecting a safety compliance action of the person, updating the safety rating of the person based at least in part on the detected safety compliance action, and updating the safety rating of the entity based at least in part on the updating of the safety rating of the person. In some cases, the entity includes a corporation, a partnership, a company, an organization, an institution, or any group of people, or any combination thereof.

### CROSS-REFERENCE TO RELATED APPLICATION

This application claims the benefit of U.S. Provisional Application No. 62/528,885, filed Jul. 5, 2017; and U.S. Provisional Application No. 62/613,922, filed Jan. 5, 2018.

### BACKGROUND

The Occupational Safety and Health Act grants Occupational Safety and Health Administration (OSHA) the authority to issue workplace health and safety regulations. These regulations include limits on hazardous chemical exposure, employee access to hazard information, requirements for the use of personal protective equipment, and requirements to prevent falls and hazards from operating dangerous equipment.

OSHA's current Construction, General Industry, Maritime and Agriculture standards are designed to protect workers from a wide range of serious hazards. Examples of OSHA standards include requirements for employers to: provide fall protection such as a safety harness/line or guardrails, prevent trenching cave-ins, prevent exposure to some infectious diseases, ensure the safety of workers who enter confined spaces, prevent exposure to harmful chemicals, put guards on dangerous machines, provide respirators or other safety equipment, and provide training for certain dangerous jobs in a language and vocabulary workers can understand.

OSHA sets enforceable permissible exposure limits (PELs) to protect workers against the health effects of exposure to hazardous substances, including limits on the airborne concentrations of hazardous chemicals in the air. Employers must also comply with the General Duty Clause of the OSH Act. This clause requires employers to keep their workplaces free of serious recognized hazards and is generally cited when no specific OSHA standard applies to the hazard. However, training and compliance by employers is often lacking.

### SUMMARY

According to at least one embodiment, a method for entity safety rating systems associated with safety and training compliance is described. In some embodiments, one or more aspects of the method may be performed by one or more processers of a mobile computing device. In some cases, the method may include generating a safety rating of an entity, generating a safety rating of a person associated with the entity, detecting a safety compliance action of the person, updating the safety rating of the person based at least in part on the detected safety compliance action, and updating the safety rating of the entity based at least in part on the updating of the safety rating of the person. In some cases, the entity may include a corporation, a partnership, a company, an organization, an institution, or any group of people, or any combination thereof. In some embodiments, updating a safety rating may include lowering a safety rating or raising a safety rating. In one example, a safety rating may include a number score such as a score range from 0 to 100, where a higher safety rating is a better safety rating. Additionally or alternatively, the safety rating may include a letter score such as a score range from the letter F to the letter A, where an F is a failing safety rating and an A is an exceptional safety rating.

In some cases, the method may include posting the entity's safety and health policy on a publically available website, on an employee accessible website, on a mobile application executing on the mobile computing device, or any combination thereof. In some cases, the method may include requesting that the person read the safety and health policy, verifying that the person has read the safety and health policy, and upon verifying that the person has read the safety and health policy, updating the safety rating of the person. In some cases, verifying that the person has read the safety and health policy may include posting on a mobile computing device of the user via the mobile application one or more questions, content from the questions being based at least in part on content from the safety and health policy, and determining whether the person provides correct answers to the one or more questions.

In some cases, the method may include providing, in the mobile application, a reporting system to enable the person to report conditions associated with the entity, receiving via the reporting system a report of a current condition provided by the person, and updating the rating of the person based at least in part on the person providing the report. In some cases, the conditions reported under the reporting system may include hazardous conditions, safety conditions, or health conditions, or any combination thereof.

In some cases, the method may include enabling, via the reporting system, the person to take one or more pictures of the current condition and to add the one or more pictures to the report. In some cases, the reporting system may automatically store the one or more pictures in local storage associated with the mobile application, on a central server, in cloud storage, or in any combination thereof. In some cases, the method may include identifying keywords associated with the current condition, selecting one or more administrators based at least in part on the identified keywords, and routing the report to the selected administrators.

In some cases, the method may include providing safety training information to the person, verifying the safety training information provided to the person, and updating the rating of the person based at least in part on the verifying of the training information. In some cases, the method may include updating the rating of the person based at least in part on a safety training attendance associated with the person, a number of safety trainings taken by the person, a frequency of safety trainings taken by the person, a score of a safety training test taken by the person, multiple safety training scores associated with the person, or any combination thereof. In some cases, the method may include updating the rating of the entity in real time based at least in part on an updated rating of the person, wherein updating the rating of the entity or updating the rating of the person, or both, is performed automatically without human intervention.

A computing device configured for improving safety and training compliance is also described. The computing device may include one or more processors and memory in electronic communication with the one or more processors. The memory may store computer executable instructions that when executed by the one or more processors cause the one or more processors to perform the steps of generating a safety rating of an entity, generating a safety rating of a person associated with the entity, detecting a safety compliance action of the person, updating the safety rating of the person based at least in part on the detected safety compliance action, and updating the safety rating of the entity based at least in part on the updating of the safety rating of the person. In some cases, the entity may include a corporation, a partnership, a company, an organization, an institution, or any group of people, or any combination thereof.

A computer-program product for improving safety and training compliance is also described. The computer-program product may include a non-transitory computer-readable medium storing instructions thereon. When the instructions are executed by one or more processors, the execution of the instructions may cause the one or more processors to perform the steps of generating a safety rating of an entity, generating a safety rating of a person associated with the entity, detecting a safety compliance action of the person, updating the safety rating of the person based at least in part on the detected safety compliance action, and updating the safety rating of the entity based at least in part on the updating of the safety rating of the person. In some cases, the entity may include a corporation, a partnership, a company, an organization, an institution, or any group of people, or any combination thereof.

According to at least one embodiment, a method for improving computer systems associated with safety and training compliance is also described. In some cases, one or more operations of the method may be performed by or in conjunction with one or more processors of one or more computing devices. In one embodiment, the method may include generating a user interface to enable configuration of an in-person event, selecting a location for the in-person event, selecting a range threshold for the selected location of the in-person event, and determining whether a first attendee attended or is attending the in-person event based at least in part on a location of the first attendee relative to the location of the in-person event.

In some embodiments, the method may include receiving a start indication based at least in part on a scheduled start of the in-person event or receiving the start indication from an administrator of the in-person event, or both, wherein the start indication indicates a start to the in-person event. In some embodiments, the method may include sending a starting prompt to one or more mobile devices upon receiving the start indication, wherein the starting prompt includes at least one of a join button and a decline button, or both.

In some embodiments, the method may include receiving a join response to the starting prompt from a mobile device associated with the first attendee and determining whether a location of the mobile device associated with the first attendee is within the range threshold upon receiving the join response. In some embodiments, the method may include marking the first attendee as being present at the in-person event based at least in part on receiving the join response and determining the location of the mobile device associated with the first attendee satisfies the range threshold.

In some cases, the location of the mobile device may be determined by at least one of a global positioning system (GPS), local positioning system (LPS), indoor positioning system (IPS), wireless positioning system (WPS), and short range wireless positioning system, or any combination thereof. In some embodiments, the method may include receiving a decline response to the starting prompt from a mobile device associated with a second attendee and marking the second attendee as not attending the in-person event or removing a registration of the second attendee for the in-person event, or both.

In some embodiments, the method may include sending an intermediary prompt to each mobile device that joins the in-person event, the intermediary prompt being sent any time after the start of the in-person event up to an end of the in-person event. In some cases, a response to the intermediary prompt may indicate the attendee remains at the in-person event, participates in the in-person event, or both.

In some cases, the range threshold may indicate at least a central location and a distance from the central location. In some examples, the location of the in-person event may include at least one of a physical address of the location of the in-person event, coordinates of the location of the in-person event, a pinpoint on mapping software of the location of the in-person event, or any combination thereof. In some cases, configuration of the in-person event may include configuring at least one of a start time, an end time, a duration, a date, a topic, an assigned speaker, and the location of the in-person training, or any combination thereof.

In some embodiments, the method may include scheduling media content in a certain order for distribution to one or more users based at least in part on predetermined work schedule of the one or more users, distributing at least one media file per work day to the one or more users based at least in part on the scheduled order of the media content, pausing the schedule of the media content based at least in part on a pause request from at least one of the one or more users, and automatically restarting distribution of the at least one media file per work day based at least in part on an end date designated in the pause request. In one example, delivery schedule may be once a day or once every other day, or less frequently (e.g., once every other day, once a week, once every two weeks, once a month, etc.). In some cases, the one or more users may include one or more individual users and/or one or more groups of users. In some cases, the pause request may include a start date and an end date. In some cases, the media content may include multiple media files such as the at least one media file.

In some embodiments, the method may include scheduling media content in a certain order for distribution to one or more users based at least in part on predetermined work schedule of the one or more users, distributing at least one media file per work day to the one or more users based at least in part on the scheduled order of the media content, identifying a user from the one or more users not watching the at least one media file on a day the at least one media file was distributed to the user, and sending a warning message to a mobile device associated with the user. In some cases, the warning message may indicate a deadline by which time the user may consume the at least one media file without incurring a penalty. Additionally or alternatively, the warning message may indicate the user is in violation of training protocol.

A computing device configured for improving safety and training compliance is also described. The computing device may include one or more processors and memory in electronic communication with the one or more processors. The memory may store computer executable instructions that when executed by the one or more processors cause the one or more processors to perform the steps of generating a user interface to enable configuration of an in-person event, selecting a location for the in-person event, selecting a range threshold for the selected location of the in-person event, and determining whether a first attendee attended or is attending the in-person event based at least in part on a location of the first attendee relative to the location of the in-person event.

A computer-program product for improving safety and training compliance is also described. The computer-program product may include a non-transitory computer-readable medium storing instructions thereon. When the instructions are executed by one or more processors, the execution of the instructions may cause the one or more processors to perform the steps of generating a user interface to enable configuration of an in-person event, selecting a location for the in-person event, selecting a range threshold for the selected location of the in-person event, and determining whether a first attendee attended or is attending the in-person event based at least in part on a location of the first attendee relative to the location of the in-person event.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is a block diagram illustrating one embodiment of an environment in which the present systems and methods may be implemented;

FIG. 2 is a sample interface illustrating one example of one or more modules in accordance with various aspects of this disclosure;

FIG. 3 is a sample interface illustrating one example of one or more modules in accordance with various aspects of this disclosure;

FIG. 4 is a sample interface illustrating one example of one or more modules in accordance with various aspects of this disclosure;

FIG. 5 is a sample interface illustrating one example of one or more modules in accordance with various aspects of this disclosure;

FIG. 6 is a sample interface illustrating one example of one or more modules in accordance with various aspects of this disclosure;

FIG. 7 is a sample interface illustrating one example of one or more modules in accordance with various aspects of this disclosure;

FIG. 8 is a flow diagram illustrating one embodiment of a method in accordance with various aspects of this disclosure;

FIG. 9 is a flow diagram illustrating one embodiment of a method in accordance with various aspects of this disclosure;

FIG. 10 depicts a block diagram of a computer system suitable for implementing the present systems and methods; and

FIG. 11 depicts a block diagram of a computer system suitable for implementing the present systems and methods.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The current systems and methods are directed towards improving training costs and overhead associated with, for example, safety guidelines as well as regulations and improving computer systems associated with training and compliance. Currently, training supervisors spend considerable amounts of time tracking employee training and safety compliance. In some cases, a training supervisor may be required to maintain a paper trail in compliance with corporate guidelines as well as local, state, and/or federal laws. The paper trails may include information regarding when a training occurs, a duration of the training (e.g., 1 hour long, etc.), subject matter taught during the training, and a list of who attended the training. As a result, the training supervisor may be required to handle hundreds or thousands of sheets of training logs in order to comply with company safety guidelines and safety regulations associated with local, state, and/or federal law.

In some cases, the systems and methods may include generating one or more series of videos related to a particular topic. In some cases, each video in a given series of videos may be two minutes or shorter. As one example, a first series of videos may be on the topic of safe and proper handling of chemicals, while a second series of videos may be on the topic of safe and proper techniques of lifting objects by hand, while a third series of videos may be on the topic of safe and proper driving of vehicles. As an example, a first video in the series of videos on the topic of safe driving may cover a first aspect of texting and driving, a second video in this series may cover another aspect of texting and driving, a third video in this series may cover impaired driving, a fourth video in this series may cover drowsiness and driving, a fifth video in this series may cover drug use and driving, a sixth video in this series may cover alcohol use and driving, a seventh video in this series may cover obeying traffic laws, an eighth video in this series may cover proper procedures when a vehicle breaks down, a ninth video in this series may cover proper procedures when in a traffic accident, and the like.

In some cases, a company may assign employees to one or more work groups. In some embodiments, each work group may include a title that describes the work group. For example, a first work group of a company may be titled engineers, a second work group may be titled service drivers, a third work group may be titled manufacturing. Thus, one or more engineers from the company may be assigned to the engineer work group, one or more service drivers may be assigned to the service driver work group, and one or more manufacturing employees may be assigned to the manufacturing work group, etc.

In some embodiments, one or more series of videos may be assigned to a particular work group that includes one or more employees. Additionally or alternatively, one or more series of videos may be assigned to an individual employee. Additionally or alternatively, a single video may be assigned to a particular work group and/or individual employee.

In some embodiments, one or more videos being assigned to an employee and/or a work group of multiple employees. As an example, when one or more videos are assigned to the engineer work group, notifications for those particular videos may be scheduled to arrive each workday at 9:00 AM. In some cases, the mobile devices of each engineer assigned to the engineer work group may receive a notification for a particular video each workday at 9:00 AM. As an example, when ten videos are assigned to the engineer work group, and work days are Monday through Friday, then a notification for the first of the ten videos may be sent that Monday at 9:00 AM to the mobile device of each engineer assigned to the engineer work group, another notification for the second of the ten videos may be sent that Tuesday at 9:00 AM, and so forth. In some cases, one or more videos may be sent to all available groups.

When a particular video is scheduled for one or more users and/or groups of users, in some cases, one or more other videos may be auto-scheduled to the one or more users and/or groups of users. For example, a series of ten videos may include a first video, a second video, a third video, etc., where each video is related to the same topic and/or each video is a video in a series of related videos. In this example, when the first video, or the second video, or the third video, or any one or more of the ten videos in the series is added to a schedule, then all the videos in that series may be automatically added to the schedule.

In some cases, the daily notifications may be sent only on those days and/or hours the employee is scheduled to be at work or on the clock. For example, when an employee works Monday through Friday and has Saturday and Sunday off, the employee may receive notifications each weekday Monday through Friday, but receive no notifications Saturday or Sunday. Similarly, when the employee works 8:00 AM to 5:00 PM, the notifications may be sent only during the hours 8:00 AM to 5:00 PM. If the video is two minutes long, then the notification may be sent two or more minutes before 5:00 PM when the workday ends for the employee. Thus, even if a video is scheduled to arrive each day at 7:00 AM, but the employee is scheduled to start work at 8:00 AM, the system may automatically reschedule the notification to arrive after 8:00 AM (i.e., the start time) on the mobile device of the employee. Additionally or alternatively, notifications may be sent based on a detected location of the employee. For example, an employee may be checked in to work automatically based on a detected location of the employee.

Upon detecting the employee being checked-in to work, the present system and methods may in response send the scheduled daily video prompt to at least one of a designated computing device of the employee, to an application installed on a computing device of the employee, to an email of the employee, and to a text messaging number of the employee, or any combination thereof. Thus, for example, when a video is scheduled to arrive at 7:00 AM on a workday based on a work schedule of the employee, but the present systems and methods determine the employee has not yet checked in, the present systems and methods may delay sending the video prompt until detecting the employee is checked-in for work. Alternatively, in one example, when a video is scheduled to arrive at 7:00 AM on a work day based on a work schedule of the employee, but the present systems and methods determine the employee is in a non-work location (e.g., in another state, out of the country, etc.), the present systems and methods may delay sending the video prompt until the next time the employee is detected checking in for work.

In one embodiment, the present systems and methods may monitor a location of a computing device associated with an employee such as monitoring a smart phone associated with the employee, etc. In some cases, the present systems and methods may perform one or more operations based on the determined location of the employee. For example, the present systems and methods may automatically check an employee in to an event based on the determined location of the employee. In this example, at a predetermined time (e.g., a day before the event, 5 minutes before the event, at the time of the event, etc.) the present systems and methods may identify a scheduled event associated with the employee. As one example, the present systems and methods may determine the location of the employee at the time of the event. When it is determined the employee is at the location of the event at the time the event is scheduled to begin, the present systems and methods may record that the employee is at the event at the starting time of the event.

As an example, the present systems and methods may determine at least one of a scheduled start time of an in-person event, a scheduled location of an in-person event, an employee registered to attend an in-person event, that an employee is at the location of the in-person event, that the employee is at the location of the in-person event at the starting time of the in-person event, or any combination thereof. As a result, the present systems and methods may automatically check the employee as attending the in-person event based on the determined location of the employee at the starting time of the in-person event. In some cases, the present systems and methods may use the determined location of the employee to automatically clock the employee in at a predetermined worksite (e.g., at a place of business or at a remote location), record an arrival time of the employee in relation to the event, record a duration of stay, record a departure time upon detecting the location of the employee indicates the employee is a predetermined distance away from the worksite, record a break time away from the worksite, record a lunch break, record a return from a lunch break, or any combination thereof. Additionally or alternatively, an employee may enter an employee number to clock the employee in/out, record an arrival time, record a departure time, and/or perform any of the other actions described herein.

In some cases, one or more questions may be displayed on a mobile device before, during, and/or after a video is watched to an employee. In some cases, the questions may be used to verify whether the employee actually watched the video and/or paid attention to the content of the video. In some cases, an employee may receive feedback on whether the answers provided are correct. In some cases, upon determining the employee provides an incorrect answer, the present systems and methods may indicate the incorrect answer selected by the employee as well as show the correct answer. In some cases, the present systems and methods may request the employee acknowledge the correct answer before allowing the employee to mark the video as having been watched. Additionally or alternatively, an employee may be asked to re-watch the video when the answers fail to satisfy a correct answer threshold. For example, the correct answer threshold may be satisfied when at least 75% of the answers are correct. Upon satisfying the correct answer threshold, a safety rating of the employee may be updated. In some cases, upon determining an employee has watched a particular video, the safety rating of the employee may be updated. Additionally or alternatively, upon determining an employee has watched a particular video, information indicating the employee has watched the video may be stored in a database. For example, at least one of the employee's name, employee number, social security number, address, title, video information, and employer information, or any combination thereof, may be stored in a local and/or remote database such as cloud storage.

In some cases, the present systems and methods may maintain statistics of an employee in relation to consuming scheduled media content. In some cases, the statistics may include a total number of media files received, a number of media files opened and/or consumed, and the like. Consuming media files may include watching a media file, listening to a media file, playing a media file, interacting with a media file, reading a media file, etc. In some cases, consuming a media file may be based at least in part on watching, listening, playing, and/or interacting with the media file for at least a predetermined amount of time. As one example, the statistics may include a number of videos watched overall, a number of videos watched in a specified time period (e.g., week, month, year, etc.), a video watching streak, a number of days without missing a video, a percentage of videos actually watched in relation to a number of videos expected to have watched, a percentage of correctly answered questions in relation to one or more watched videos, a safety rating of the employee, a safety rating of an entity associated with the employee, or any combination thereof. In some cases, the statistics may include a gamification feature that enables a user to track his/her safety training progress in relation to one or more other users in the same organization, in the same industry, in the same geographic region, in the same country, in the world, etc. In one example, the statistics may include badges earned by a user based on the video watching streak, the number of days without missing a video, the percentage of videos actually watched in relation to a number of videos expected to have watched, the percentage of correctly answered questions in relation to one or more watched videos, the safety rating of the employee, the safety rating of the entity associated with the employee, or any combination thereof. In some cases, the statistics may include a ranking showing how the user ranks against fellow employees, against other users in the same industry, against other users in the same geographic region (e.g., state, province, etc.), against others users in the same nation, against other users worldwide, or any combination thereof.

In some embodiments, a safety rating of an employee may be determined and/or updated (e.g., lowered, maintained, or raised) based at least in part on the employee watching or not watching videos, a frequency of watching videos, the employee taking or not taking quizzes, a frequency of taking quizzes, the employee attending or failing to attend live trainings, the employee reading or failing to read company policies, the employee verifying through specific actions that an action was performed or a policy was read, the employee reporting an incident or failing to report an incident, a reaction time to reporting an incident, a number of incidents associated with the employee, an occurrence of a particular incident associated with the employee, a frequency of incidents associated with the employee, or any combination thereof. Examples of incidents include identifiable potential safety risks, identifiable potential health risks, identifiable potential environmental risks, accidents involving injury to one or more employees of the entity, accidents involving injury to customers of the entity and/or innocent bystanders, accidents involving injury to property of the entity, accidents involving injury to property of a third party, or any combination thereof.

In one embodiment, as indicated above an entity may be assigned a safety rating. The safety rating of the entity may be based at least in part on the safety ratings of one or more employees of the entity. Additionally or alternatively, the safety rating of the entity may be based at least in part on actions taken by the entity, actions not taken by the entity, delays in actions taken by the entity, or any combination thereof. In some cases, the safety rating of the entity may be based at least in part on proactive actions taken by the entity (e.g., actions taken before an incident occurs or actions taken to prevent a potential incident from occurring) and on reactive actions taken by the entity (e.g., actions taken after an incident occurs, the entity's reaction time to the incident, etc.). As one example, a safety rating of an entity may be determined based at least in part on a first employee reading an entity safety policy posted in a mobile application, the first employee recognizing a potential safety hazard as a result of reaching the entity safety policy, the first employee reporting the potential safety hazard to a supervisor (a second employee) via the mobile application, the second employee taking remedial action to abate the potential hazard, the second employee reporting the remedial action via the mobile application, the mobile application generating a notification regarding the remedial action, an administrator or officer of the entity receiving the notification, the administrator or officer of the entity taking timely action in response to the notification, and the administrator or officer of the entity reporting the timely action to a regulation agency. In some cases, the safety rating of the entity may be affected by an employee terminating employment with the entity. Upon making the termination final, the present systems and methods may update the safety rating of the entity in real time (e.g., by removing the safety rating of the terminated employee as a factor in determining the safety rating of the entity).

In some cases, a safety rating of an entity may be determined and/or updated (e.g., lowered, maintained, or raised) based at least in part on an updating of the safety rating of one or more employees, the entity reporting an incident or failing to report an incident, a reaction time to reporting an incident, an occurrence of a particular incident, a number of incidents associated with the entity, an incident history, an incident frequency, a severity of one or more incidents, an interaction between the entity and an employee or customer, an interaction between the entity and a regulated agency OSHA, environment protection agency (EPA), etc.), a compliance or lack of compliance by the entity to a regulation (e.g., safety regulation, health regulation, environment regulation, etc.), or any combination thereof.

In some embodiments, the safety rating may be based at least in part on entity providing measurable training platforms to its employees, maintaining and displaying company policy on health and safety issues, and distributing company policy over a mobile software application to make the policy available at all times to each of its employees. In some cases, the safety rating of the entity may be based at least in part on response and abatement plans established by the entity and the effectiveness of the entity in following through on these plans. In some cases, the safety rating of the entity may be based at least in part on the entity successfully addressing feedback to employee's safety concerns. In some cases, the safety rating of the entity may be based at least in part on actions taken by the entity.

In some embodiments, the present systems and methods may enable a first entity to interact with a second entity (e.g., via a mobile software application). As one example, an employee or officer of a first entity may submit a safety-related question via a mobile application executing on a smartphone of the employee or officer. In some cases, the employee or officer may select one or more other entities to view the submitted question. Accordingly, one or more employees or officers of a second entity selected to receive the question may receive a notification regarding the question. The same mobile application, another copy executing on another mobile computing device, may then enable the employee or officer of the second entity to submit a response to the question submitted by the employee or officer of the first entity, which may then be relayed to the employee or officer of the first entity via the mobile application.

In some embodiments, the present systems and methods may give a third party access to statistics of one or more other third-party entities. As one example, the present systems and methods may give a general contractor access to training records of one or more sub-contractors associated with the general contractor. In one example, a general contractor may review the training records of one or more different sub-contractors to determine which sub-contractor to hire for a specific job. Additionally, a general contractor may review training performance of a sub-contractor hired to perform a certain job. In one example, a government agency may be given access to training records of one or more third-party entities to confirm compliance. In some cases, a safety rating of an employee and/or entity may be provided to a government agency. In another example, an insurance company may be given access to training records from an insured client in order to determine whether to give an insurance discount to the insured client and/or determine how much of a discount to give on the insurance of the insured client. In some cases, a safety rating of an employee and/or entity may be provided to an insurance company to enable the insurance company to provide an insurance quote and/or adjust an insurance policy based on the one or more provided safety ratings.

In some embodiments, the present systems and methods may enable a user to download one or more media files to a mobile device of the user. In some cases, the present systems and methods may enable the user to select an amount of time and then the present systems and methods may collect a number of media files that correlates to the selected amount of time. Accordingly, the user may consume the media files regardless of whether the user has an internet connection and/or a local network connection such as a WiFi connection. For instance, the user may travel to a remote area of the world without internet, WiFi, and/or cellular service, but may still consume the media files. As one example, a user may select one week as the amount of time. Accordingly, the present systems and methods may download a week's worth of media files to the user's mobile device. In one embodiment, the user may clock in to work without the network connection and then once the user is clocked in, the system may then provide one or more of the downloaded media files. In some cases, the present systems and methods may schedule the downloaded content and provide the content during work hours (e.g., after the user clocks in and before the user clocks out) and according to the determined content delivery schedule. In some cases, the user may answer one or more answers in relation to consuming particular media files. The present systems and methods may store associated information and provide the stored information upon detecting the mobile device connected to a network connection such as WiFi, a cellular data connection, and/or the internet. In one example, the present systems and methods may send information regarding what media files were consumed, answers provided by the user in relation to media files consumed, when the user clocked in to work, when the user clocked out of work, a location of the user when the user clocks in, a location of the user when the user clocks out, etc.

In some cases, the present systems and methods may include a menu for at least one of a dashboard view, employee view, videos view, alerts view, statistics view, settings, or any combination thereof. In some cases, the administrator dashboard may include one or more video schedules. For example, the dashboard may enable an administrator to view a list of videos assigned to an employee and/or a group of employees. In some cases, the list of videos may be shown in a sequence in which they are disbursed to the assigned employees. For example, a first listed video may be disbursed to the assigned employees on a first workday, a second listed video on a second workday following the first workday, and so forth.

In some embodiments, the administrator dashboard may include a training statistics window that gives a graphical snapshot of training progress. As one example, the training statistics window may show a percentage of videos watched per a given set of weeks. For instance, the training statistics window may show what percentage of employees watched scheduled videos for the present week and one or more previous weeks. The percentages may apply to all employees, a group of employees, one employee, or any combination thereof. Additionally or alternatively, the training statistics window may show a percentage of correct answers given in training video quizzes. For example, after a training video has been viewed, a quiz may be displayed on the watcher's mobile device asking questions regarding the content of the video he/she just finished watching. Thus, the training statistics window may show what percentage of correct answers were given in training content quizzes. The percentages may apply to all employees, a group of employees, one employee, all media content, or a portion of media content. The media content may include any combination of video files, audio files, image files, videogame files, white papers, and books.

In some cases, after receiving a notification to watch a particular video, an employee may fail to click on the notification, may not watch the video, may start the video but fail to finish watching the video, may watch the entire video but fail to answer a certain number of questions correctly, or any combination thereof. In such cases, a warning notification may be sent to a mobile device of an employee. In some cases, a safety rating of the employee may be adjusted based on the lapse in safety compliance. In some cases, a warning notification may be sent later in the same day the video is assigned to be watched reminding the employee to watch the video. Additionally or alternatively, a warning notification may be sent one or more days after the day the video is assigned to be watched.

In some cases, an employee may generate a request for the daily notifications to be temporarily paused. For example, an employee may take time off such as for a vacation and may not want to receive the daily notifications to consume certain media files (e.g., watch video files, view image files, listen to audio files, read text files, etc.) while he/she is on vacation. Accordingly, the employee may be granted a “pause” in relation to the daily notifications. During the pause, the systems and methods may bypass sending daily notifications to the employee. In some cases, the systems and methods may bypass tracking statistics for the employee during the pause. In some cases, the pause request may include a start time when the pause is scheduled to start and an end time when the pause is scheduled to stop. In some cases, the start and end times may include a date such as May 10 as a start time and May 14 as an end time. Based on this example, the video notifications and related tracking/statistics may be automatically paused on May 10 and then automatically restarted on May 14 without human intervention.

In some cases, the present systems and methods may monitor user health by one or more sensors. In some embodiments, a life sensor may be used to monitor at least one of a heart rate and a breathing rate of a user of a mobile device. In some cases, the user may wear a sensor that communicates the heart rate and/or breathing rate to a mobile device to monitor the health of the user. In some cases, a gyroscope may detect movement of a mobile device. Upon detecting no movement for a certain amount of time, the present systems and methods may generate a notification. In some cases, the notification may include a prompt requesting the user respond that all is well. In some cases, the prompt may include a text message displayed on the mobile device. Additionally or alternatively, the prompt may include an audio text to speech message and/or an audio alert such as a beeping sound that may repeat until the user responds. In some embodiments, the user may respond to the prompt by pressing a button displayed on the mobile device. In some cases, the present systems and methods may detect that a computing device of a user remains idle (e.g., through monitoring accelerometers or other sensors associated with the device) for any given predetermined amount of time (e.g., idle for five or more minutes, etc.). In some cases, the present systems and methods may determine whether the user is idle. For example, the present systems and methods may monitor one or more life signs of a user based at least in part on a biometric signal derived from monitoring a life sign of the user such as heart rate, breathing rate, etc. In some cases, the present systems and methods may monitor a signal from a wearable computer worn by the user such as a wearable heart rate monitor, etc. In some cases, the present systems and methods may prompt the user to respond upon determining the user is idle, the computing device of the user is idle, the heart rate of the user is abnormal, a breathing rate is abnormal, etc. In some cases, an audio warning may sound when the user fails to respond within a predetermined time period. If a user fails to respond to such warnings or prompts, a message may be sent to an administrator or other appropriate persons using the present systems and methods. Additionally, in some embodiments, a user may acknowledge a prompt or warning by selecting, for example, a button or other input option indicating “I need help” to call for assistance (including emergency assistance if necessary).

As one example, a first button displayed on the mobile device in relation to the prompt may read “I'm okay” and a second button may read “I need help.” Additionally or alternatively, the user may respond to the prompt using his/her voice. For example, the user may respond “I'm okay,” or “Send help,” or “I'm hurt,” using his/her voice and a microphone on the mobile device may capture the voice response. A processor on the mobile device and/or a remote system may interpret the voice message and determine an appropriate response based on the interpretation of the message. For example, upon interpreting the user stated response of “I'm okay,” the remote system may reset a timer associated with the life sensing. Upon interpreting the user stating “I'm hurt,” the remote system may determine a location of the user based on location services provided by the mobile device and send one or more notifications regarding the user's statement to an appropriate party or authority. For example, the remote system may send a notification to an administrator indicating the user's statement. In some cases, the remote system may identify emergency personnel local to the user and send a notification to the emergency personnel regarding the user's statement.

In some cases, a user interface on a user's mobile device may enable the user to create an incident report. In some cases, one or more portions of the incident report may be auto-filled based on information in a user profile of the user. For example, at least one of employee name, employee identifier, physical address, email address, phone number, age, and social security number, or any combination thereof, may be auto-populated in the incident report. In some embodiments, the present systems and methods may enable a user to take one or more photos and/or videos of the incident site and automatically attach the captured photos/videos to the incident report.

Additionally or alternatively, one or more portions of the incident report may be auto-filled based on real-time information gathered at the location of the incident. In some embodiments, the present systems and methods may determine a location of the incident based on determining a location of a device of a user determined to be at the location of the incident. For example, when the user initiates the incident report the user's mobile device may determine its location and create a geo-location stamp indicating where the incident occurred. In some cases, the mobile device may query the user to confirm that the location detected by the mobile device is the location of the incident. In some cases, the user's mobile device may create a timestamp when the user initiates the incident report, where the timestamp indicates a time of day (e.g., 11:43 AM) and/or date (e.g., Jun. 7, 2018) of the incident. In some cases, the incident report may include one or more prompts asking the user what happened in the incident, whether there are injuries to the user or others, etc.

In some cases, the present systems and methods may automatically send the incident report to one or more predetermined recipients. In some cases, the present systems and methods may identify a severity of the incident and determine recipients of the incident report based on the determined severity.

As one example, the present systems and methods may determine one or more government agencies required to receive notification of the incident by a certain deadline and automatically provide a report of the incident before the certain deadline. In some cases, the present systems and methods may provide instructions based on the indicated severity. In some cases, the present systems and methods may provide training based on the severity. For example, the present systems and methods may provide instructions in a certain order such as first do actions A, B, and C; then do action D, then do actions E and F, do not do action G, then do action H, etc. In some cases, a safety rating of an employee and/or an entity associated with the employee may be updated based on creation of the incident report. In some examples, a safety rating of an employee and/or an entity associated with the employee may be updated based on a failure to create an incident report.

In some cases, an employee, an administrator, and/or an executive of an entity may create an alert, which may be automatically sent to one or more predetermined recipients. Examples of an alert may include a road condition alert, a weather alert, a product recall alert, a product safety alert, a public safety alert, an alert of an accident that has occurred, and the like. In some cases, the alert may include at least a high level alert, a medium level alert, and a low level alert. In some cases, the present systems and methods may track who has received the alert, who has received the alert and viewed the alert, who has received the alert and not viewed the alert, and perform one or more operations based on at least one of these determinations.

In some cases, the present systems and methods may send an additional prompt to users that have received the alert but have not yet viewed the alert. For example, the present systems and methods may send an additional notification (e.g., text message, in-application message, email, etc.) to users that have received the alert but have not yet viewed the alert. In some cases, after a predetermined amount of time upon determining a user has received but not viewed the alert, a notification may be sent to an administrator that identifies the user and the alert the user was sent, and also indicates the user has received the alert but has not viewed the alert. In some cases, a prompt may be sent to a device associated with the user regarding not viewing the alert. In some examples, the prompt may include an audio text to speech message and/or an audio alert such as a beeping sound that may repeat until the user responds. In some cases, the present systems and methods may send an additional prompt only after determining the recipient is on the clock at work. In some examples, at least some alerts may be paused in relation to an employee being granted a pause in relation to daily notification of scheduled media content. Accordingly, during the pause the systems and methods may bypass sending at least some alerts to the employee. In some cases, the systems and methods may bypass sending reminders and/or additional notifications regarding unopened or unviewed alerts during the pause.

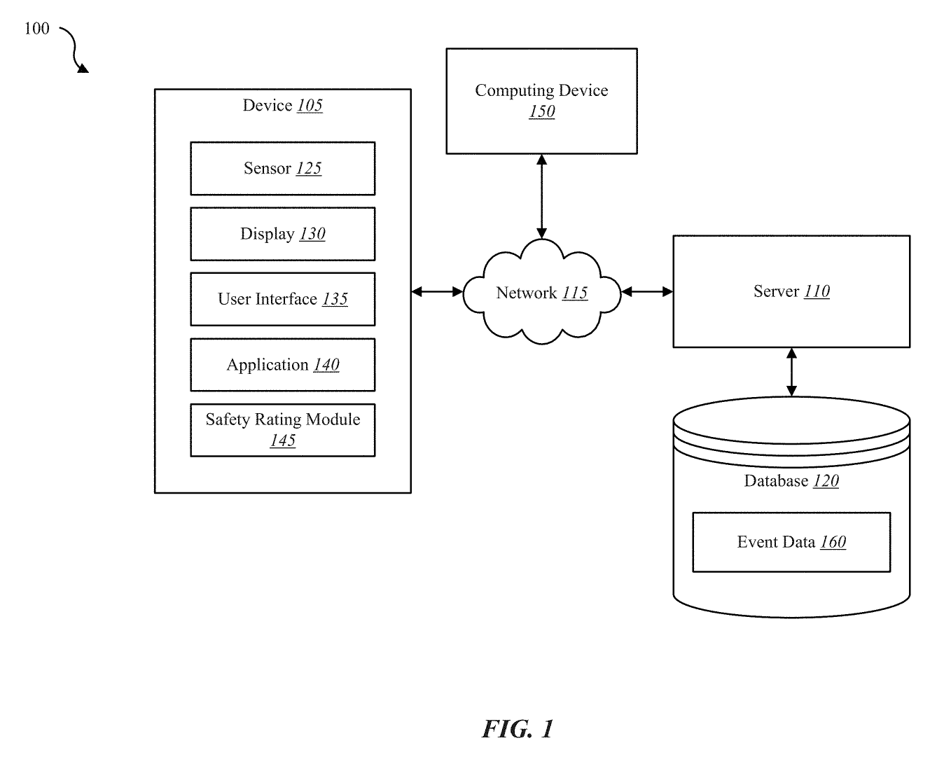

FIG. 1 is a block diagram illustrating one embodiment of an environment 100 in which the present systems and methods may be implemented. In some embodiments, the systems and methods described herein may be performed on a device (e.g., device 105). As depicted, the environment 100 may include a device 105, server 110, a computing device 150, and a network 115 that allows the device 105, the server 110, and computing device 150, to communicate with one another.

Examples of the device 105 may include any combination of mobile devices, smart phones, wearable computing devices (e.g., computer watch, computer eyewear, etc.), personal computing devices, computers, laptops, desktops, servers, media content set top boxes, digital video recorders (DVRs), or any combination thereof. In some cases, device 105 may include a device integrated within computing device 150, and/or as depicted, may be in communication with one or more remote devices via network 115.

Examples of computing device 150 may include at least one of one or more client machines, one or more mobile computing devices, one or more laptops, one or more desktops, one or more servers, one or more media set top boxes, or any combination thereof. Examples of server 110 may include any combination of a data server, a cloud server, proxy server, mail server, web server, application server, database server, communications server, file server, home server, mobile server, name server, or any combination thereof. Although computing device 150 is depicted as connecting to device 105 via network 115, in one embodiment, device 105 may connect directly to computing device 150. In some cases, device 105 may connect or attach to computing device 150 and/or server 110 via a wired and/or wireless connection. In some cases, device 105 may attach to any combination of a port, socket, and slot of computing device 150 and/or server 110.

In some configurations, the device 105 may include a sensor 125, a display 130, a user interface 135, one or more applications 140, and safety rating module 145. Although the components of the device 105 are depicted as being internal to the device 105, it is understood that one or more of the components may be external to the device 105 and connect to device 105 through wired and/or wireless connections. In some embodiments, application 140 may be installed on computing device 150 in order to allow a user to interface with a function of device 105, safety rating module 145, computing device 150, and/or server 110.

Examples of sensor 125 may include any combination of a camera sensor, audio sensor, proximity sensor, boundary sensor, accelerometer, gyroscope, global positioning system (GPS) sensor, local positioning system (LPS) sensor, Wi-Fi positioning system sensor, near-field sensor, movement sensor, microphone sensor, voice sensor, life sign sensors, other types of sensors, actuators, or combinations thereof. Sensor 125 may represent one or more separate sensors or a combination of two or more sensors in a single device. For example, sensor 125 may represent one or more camera sensors of device 105. For example, sensor 125 may include at least one of a front-facing camera and a rear facing camera. In some cases, sensor 125 may include one or more speakers. Sensor 125 may be integrated with an identity detection system such as a facial recognition system and/or a voice recognition system.

In some embodiments, device 105 may communicate with server 110 via network 115. Examples of network 115 may include any combination of cloud networks, local area networks (LAN), wide area networks (WAN), virtual private networks (VPN), wireless networks (using 802.11, for example), cellular networks (using 3G and/or LTE, for example), etc. In some configurations, the network 115 may include the Internet. It is noted that in some embodiments, the device 105 may not include safety rating module 145. For example, device 105 may include an application 140 that allows device 105 to interface with a separate device via safety rating module 145 located on another device such as computing device 150 and/or server 110. In some embodiments, device 105, computing device 150, and server 110 may include safety rating module 145 where at least a portion of the functions of safety rating module 145 are performed separately and/or concurrently on device 105, computing device 150, and/or server 110. Likewise, in some embodiments, a user may access the functions of device 105 (directly or through device 105 via safety rating module 145) from computing device 150. For example, in some embodiments, computing device 150 includes a mobile application that interfaces with one or more functions of device 105, safety rating module 145, and/or server 110.

In some embodiments, server 110 may be coupled to a database 120. Database 120 may be internal or external to the server 110. In one example, device 105 may be coupled to database 120. For example, in one embodiment database 120 may be internally or externally connected directly to device 105. Additionally or alternatively, database 120 may be internally or externally connected directly to computing device 150 and/or or one or more network devices such as a gateway, switch, router, intrusion detection system, etc. Database 120 may include event data 160. As one example, device 105 may access event data 160 in database 120 over network 115 via server 110. Event data 160 may include data of and/or regarding at least one of media content such as training videos, safety videos, scheduled pause requests, approved pause times, user profile information, live training information, alerts, incident reports, and statistics, or any combination thereof.

Safety rating module 145 may enable an improvement of safety and/or training compliance associated with, for example, legal and/or corporation mandates. In some embodiments, safety rating module 145 may be configured to perform the systems and methods described herein in conjunction with user interface 135 and application 140. User interface 135 may enable a user to interact with, control, and/or program one or more functions of safety rating module 145. Further details regarding the safety rating module 145 are discussed below.

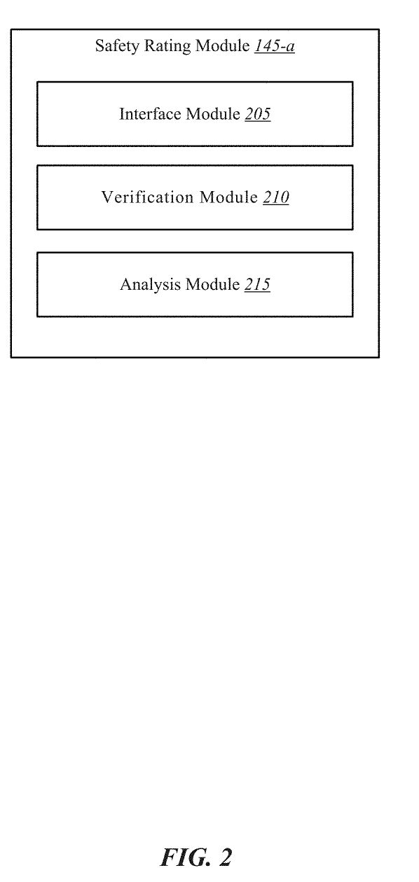

FIG. 2 is a block diagram illustrating one example of safety rating module 145-a. Safety rating module 145-a may be one example of safety rating module 145 depicted in FIG. 1. As depicted, safety rating module 145-a may include interface module 205, verification module 210, and analysis module 215.

In one embodiment, one or more operations of safety rating module 145-a, interface module 205, verification module 210, or analysis module 215, or any combination thereof, may be performed in conjunction with and/or by a computing device. As one example, one or more of the operations may be performed in conjunction and/or by a mobile computing device or a mobile application, or both. In some cases, one or more of the operations may be performed automatically without human intervention. In one embodiment, interface module 205 may be configured to generate a safety rating of an entity, the entity including a corporation, a partnership, a company, an organization, an institution, or any group of people, or any combination thereof.

In some embodiments, interface module 205 may be configured to generate a safety rating of a person associated with the entity. In some embodiments, analysis module 215 may be configured to detect a safety compliance action of the person. For example, analysis module 215 may detect an action by the person, analyze the action, and determine that the action is an action that satisfies one or more requirements for an action to be considered a safety compliance action. Examples of safety compliance actions include the person reading a safety and/or health policy of an entity, verifying the person read the policy, the person watching a safety training video, the person attending a live safety training, the person taking a safety training quiz, the person passing a safety training quiz, the person reporting an incident related to safety condition and/or health condition, the person taking a picture of the incident, the person posting the report of the incident and/or information related to the incident, or any combination thereof.

In some embodiments, interface module 205 may be configured to update the safety rating of the person based at least in part on the detected safety compliance action. In some embodiments, interface module 205 may be configured to update the safety rating of the entity based at least in part on the updating of the safety rating of the person. In some embodiments, interface module 205 may be configured to post the entity's safety and health policy on a publically available website, on an employee accessible website (e.g., a website accessible only to employees or a certain group of employees such as a password-protected website or website available only on an intranet, etc.), on a mobile application executing on the mobile computing device, or any combination thereof. In some cases, an employee accessible website may include an authentication process the employee must perform to gain access to content on the employee accessible website.

In some embodiments, interface module 205 may request that the person read the safety and health policy. In one embodiment, verification module 210 may be configured to verify that the person has read the safety and health policy. In some embodiments, interface module 205 may update the safety rating of the person upon verifying that the person has read the safety and health policy. In some cases, verifying that the person has read the safety and health policy may include posting on a mobile computing device of the user via the mobile application one or more questions, content from the questions being based at least in part on content from the safety and health policy, and determining whether the person provides correct answers to the one or more questions.

In some embodiments, interface module 205 may provide, in conjunction with a mobile application, a reporting system to enable a person to report conditions associated with an entity. In some embodiments, interface module 205 may receive via the reporting system a report of a current condition provided by the person. In some embodiments, interface module 205 may update the rating of the person based at least in part on the person providing the report. In some cases, the conditions reported under the reporting system may include hazardous conditions, safety conditions, or health conditions, or any combination thereof.

In some embodiments, interface module 205 may enable, via the reporting system, a person to take one or more pictures of the current condition and to add the one or more pictures to the report of the current condition. In some cases, the reporting system may automatically store the report and/or the one or more pictures in local storage associated with the mobile application, on a central server, in cloud storage, or in any combination thereof.

In some embodiments, analysis module 215 may analyze words associated with a report of a current condition and from the analysis identify keywords associated with the current condition. In some embodiments, interface module 205, in conjunction with analysis module 215, may select one or more administrators based at least in part on the identified keywords. In some embodiments, interface module 205 may route the report to the selected administrators.

In some embodiments, interface module 205 may provide safety training information to the person. In one embodiment, verification module 210 may be configured to verify the safety training information provided to the person. In some embodiments, interface module 205 may update the rating of the person based at least in part on the verifying of the training information.

In some embodiments, interface module 205 may update the rating of the person based at least in part on a safety training attendance associated with the person, a number of safety trainings taken by the person, a frequency of safety trainings taken by the person, a score of a safety training test taken by the person, multiple safety training scores associated with the person, or any combination thereof.

In some embodiments, interface module 205 may update the rating of the entity in real time based at least in part on an updated rating of the person. In some embodiments, interface module 205 updating the rating of the entity in real time may include interface module 205 making the real-time update immediately available to one or more third parties. For example, at the same time the safety rating of the entity is updated, the interface module 205 may make the updated safety rating available to one or more third parties external to the entity. As one example, interface module 205 may make the updated safety rating available to a third-party credit monitoring service, enabling the third-party credit monitoring service to update a credit rating based at least in part on the updated safety rating.

In some embodiments, an in-person event may include an event identifier (ID) uniquely associated with the in-person event. In some cases, an attendee may be a registered user of an event system associated with an in-person event. In one embodiment, the safety rating module 145-a may provide and/or configure one or more aspects of the event system. In some embodiments, the event system may be an online event system. In some cases, the event system may include one or more user interfaces. For example, a user interface of the event system may be configured to enable an administrator or organizer to configure one or more aspects of the in-person event. The same user interface, or a different user interface, of the event system may be configured to enable an attendee to register for the in-person event. In some cases, a user interface of the event system may enable an attendee to register as a user of the event system. In some cases, an attendee may register for the in-person event in conjunction with a computing device such as a desktop, laptop, mobile computing device, etc.

In one embodiment, interface module 205 may be configured to generate a user interface to enable configuration of an in-person event. In some cases, configuration of the in-person event includes configuring at least one of a start time, an end time, a duration, a date, a topic, an assigned speaker, and the location of the in person training, or any combination thereof. In some cases, interface module 205 may enable an administrator of an in-person event to perform one or more tasks associated with an in-person event. In some embodiments, interface module 205 may enable an administrator to perform at least one of the acts of creating an in-person event, specifying one or more aspects related to the in-person event, starting an in-person event, and ending an in-person event, or any combination thereof.

In some cases, interface module 205 may enable an attendee to register for an in-person event. In some embodiments, the attendee may be associated with user credentials. In some embodiments, interface module 205 may authenticate an identity of the attendee based at least in part on the user credentials of the attendee. In some cases, the attendee may have a user profile stored on the event system. In some cases, the user credentials and/or user profile of the attendee may include at least one of a user name, user password, a user ID, a device ID such as a media access control (MAC) address or some other identifier, an email address of the attendee, a phone number of the attendee, a given name of the attendee, a physical address of the attendee, a company associated with the attendee, or any combination thereof. In some cases, in conjunction with interface module 205, the attendee may use his/her user credentials to log in to the event system. In some cases, the attendee may participate in the in-person event based at least in part on logging in to the event system. In some cases, the user credentials of the attendee may be associated with the mobile device of the attendee. In one embodiment, interface module 205 may verify the user credentials and/or verify the device ID to permit the attendee to log in to the event system. For example, when the interface module 205 authenticates the user credentials of the attendee, the interface module 205 may also determine whether the device that is used by the attendee to provide the user credentials is registered to the attendee. In some cases, interface module 205 may prevent the attendee from logging into the event system when the user credentials fail to authenticate and/or when the device ID is not associated with the attendee.

In some cases, interface module 205 may verify the identity of the attendee in conjunction with verification module 210 in association with determining whether the location of the mobile device of the attendee matches the location of the in-person event. As stated, in some cases, the attendee may be authenticated based at least in part on verifying user credentials. Additionally or alternatively, the attendee may be authenticated based at least in part on interface module 205 verifying at least one of a written signature of the attendee, a fingerprint of the attendee, a voice signature of the attendee, and a facial signature of the attendee, some other biometric identifier, or any combination thereof. As one example, a microphone of a mobile device associated with the attendee may record the attendee speaking into the microphone such as speaking his/her name and interface module 205 may verify the voice recorded is the voice of the attendee based at least in part on comparison with a voice signature of the attendee. As another example, a camera on the mobile device may record one or more images of the attendee's face and interface module 205, in conjunction with analysis module 215, may compare the captured images to at least one facial signature of the attendee to verify the attendee is at the same location as the attendee's mobile device. As another example, the user interface associated with the event system may record the attendee writing his/her signature on a screen of the associated mobile device and interface module 205 may compare the captured signature with a saved written signature of the attendee to verify the signatures match. In some cases, interface module 205 may verify the fingerprint signature of the attendee in conjunction with a fingerprint scanner on the mobile device.

In some embodiments, verification module 210 may be configured to identify a location for the in-person event. In some cases, verification module 210 may identify the location of the in-person event based at least in part on a selection of the location made in relation to a user interface. In some cases, the location of the in-person event includes at least one of a physical address of the location of the in-person event, coordinates of the location of the in-person event, a pinpoint on mapping software of the location of the in-person event, or any combination thereof.

In some embodiments, verification module 210 may be configured to select and/or implement a range threshold for the selected location of the in-person event. In some cases, the range threshold may indicate at least a central location and a distance from the central location. For example, the range threshold may indicate a range or radius of 200 feet from the location of the in-person event. In some cases, the selected location of the in-person event may include a general location and a central location. As an example, the general location of the in-person event may be indicated by a physical address where the in-person event takes place. A central location of the in-person event may include a fine-tuned location at the physical address such as a particular room or suite at the physical address.

In some cases, the central location may be determined based at least in part on a location of a computing device associated with a presenter and/or administrator of the in-person event. For example, a presenter of the in-person event may have a computing device such as a laptop, tablet computer, and/or smart phone. A determined location of at least one computing device with the presenter at the location of the in-person event may be associated with the central location. In some embodiments, a location of the one or more computing devices of the presenter may be determined by at least one of a global positioning system (GPS), local positioning system (LPS), indoor positioning system (IPS), wireless positioning system (WPS), short range wireless positioning system, triangulation, trilateration, and multilateration, or any combination thereof associated with the one or more computing devices. Accordingly, in some cases, the range threshold may be associated with the determined central location of the presenter and a range or radius from that central location such as 150 feet within the central location of the presenter.

In some embodiments, verification module 210 may be configured to determine, in conjunction with analysis module 215, whether an attendee attended or is attending the in-person event. In some cases, verification module 210 may determine whether an attendee attends the in-person event based at least in part on a determined location of the attendee relative to the location of the in-person event. In some cases, the location of the attendee may be determined by determining a location of a mobile device associated with the attendee, comparing the location of the mobile device relative to the location of the in-person event, and then determining whether the location of the mobile device satisfies a range threshold based at least in part on the comparison.

In some cases, the location of the mobile device of the attendee may be determined by at least one of GPS, LPS, IPS, WPS, and short range wireless positioning system, or any combination thereof. As one example, one or more IPS devices may determine a central location of a computing device of a presenter at the general location of the in-person event. As one example, verification module 210 may assign a range threshold of 150 feet in relation to the identified central location of the presenter of the in-person event. Verification module 210 may determine a location of a mobile device of an attendee of the in-person event. In some cases, analysis module 215 may compare the determined location of the attendee's mobile device in relation to the central location of the presenter and the range threshold to determine whether the mobile device of the attendee is no more than, for example, 150 feet away from the central location of the presenter.

Using the same non-limiting example of a range threshold of 150 feet, the verification module 210 may indicate that the attendee satisfies the range threshold for the in-person event or that the attendee is within an attendance zone of the in-person event upon determining that the attendee's mobile device is no more than 150 feet away from the central location of the presenter. Additionally or alternatively, using the same non-limiting example of a range threshold of 150 feet the verification module 210 may indicate that the attendee satisfies the range threshold for the in-person event or that the attendee is within an attendance zone of the in-person event upon determining that the attendee's mobile device is no more than 150 feet away from the central location of a predetermined location. For example, while in some cases a presenter may be at the location of the in person-event, in other cases the presenter may be at a different location than the in-person event. In some cases, interface module 205 may display a warning on the screen of the mobile device in relation to a start time and a current location of the attendee's mobile device. As one example, when verification module 210 detects the mobile device is outside the attendance zone at a start time, after a start time, and/or at one or more certain times before the start time of the in-person event (e.g., 5 minutes before the in-person event, 10 minutes before the in-person event, etc.), interface module 205 may display a warning indicating the mobile device is outside the range threshold. In some cases, the warning may indicate how much time is left before the in-person event starts or how much time is left in the in-person event, etc. In one example, when verification module 210 detects the mobile device approaching the range threshold from within the attendance zone, interface module 205 may display a warning indicating the mobile device is approaching the range threshold and/or indicate the mobile device is about to leave the attendance zone.

In some cases, interface module 205 may be configured to receive a start indication based at least in part on a scheduled start of the in-person event or receiving an input from an administrator of the in-person event, or both. In some cases, the start indication indicates the beginning of the in-person event. As one example, an in-person event may have a start time of 9:00 AM and so a start indication may be generated based at least in part on the scheduled time of 9:00 AM. Additionally or alternatively, a presenter or administrator of the in-person event may press a start button on a user interface to indicate the start of the in-person event and as a result the start indication may be generated and transmitted to one or more computing devices associated with the in-person event.

In some embodiments, interface module 205 may be configured to send a starting prompt to one or more mobiles devices upon receiving the start indication. In some cases, the starting prompt includes at least one of a join button and a decline button, or both. In some embodiments, interface module 205 may send the starting prompt to each mobile device associated with the in-person event. As an example, interface module 205 may send the starting prompt to each mobile device associated with a registration for the in-person event.

In some embodiments, interface module 205 may be configured to receive a join response to the starting prompt from a mobile device associated with the attendee. In some cases, the join response may include location information regarding the location of the mobile device. As one example, a user of the mobile device may press a join button on a screen of the mobile device. Pressing the join button may include tapping on the join button, touching the join button, clicking on the join button, etc. In some cases, the mobile device may send a message to one or more remote computing devices indicating the pressing of the join button. In some cases, the verification module 210 may determine the location of the mobile device in relation to the user pressing the join button. For example, the verification module 210 may determine the location of the mobile device upon detecting the user pressing the join button. In some embodiments, information regarding the determined location of the mobile device may be included in the message indicating the pressing of the join button.

In some cases, a join response may indicate a location of a mobile response. For example, the join response may include information based on at least one of GPS, LPS, IPS, WPS, and short range wireless positioning system, or any combination thereof. In some embodiments, analysis module 215 may be configured to analyze a join response to determine whether a location of the mobile device indicated in the join response satisfies the range threshold. In some cases, interface module 205 may mark the attendee as being present at the in-person event based at least in part on receiving the join response and determining the location of the mobile device associated with the attendee satisfies the range threshold.

In some embodiments, interface module 205 may be configured to receive a decline response to the starting prompt from a mobile device associated with an attendee. In some cases, interface module 205 may mark the attendee as not attending the in-person event or remove a registration of the attendee for the in-person event, or both, upon receiving a decline response from an associated mobile device. In some cases, a predetermined timeout period may be associated with the starting prompt. For example, a timeout period of 5 minutes may be associated with the starting prompt. In some cases, the timeout period may be initiated at the time the starting prompt is sent and/or received. In some cases, when the timeout period elapses an attendee may be marked absence in relation to the in person training. For instance, a mobile device of a registered attendee may receive the starting prompt and display the starting prompt and/or a notification of the starting prompt on a screen of the mobile device. Accordingly, when the starting prompt is received at 9:00 AM for an in-person event scheduled to start at 9:00 AM and the predetermined timeout period is 5 minutes, then the interface module 205 may mark the registered attendee as absent when the attendee fails to respond to the starting prompt by 9:05 AM.

In some embodiments, interface module 205 may be configured to send at least one intermediary prompt to one or more mobile devices that joins the in-person event. In some cases, the intermediary prompt may be sent any time after the start of the in-person event up to the end of the in-person event. In some cases, a response to the intermediary prompt may indicate the attendee remains at the in-person event, participates in the in-person event, or both. For example, an intermediary prompt may include one or more questions associated with content shared at the in-person event. A mobile device of an attendee may display the one or more questions with answer options for each question. The attendee may select what he/she thinks is the right answer for each question and submit the answers as a response to the intermediary prompt. In some cases, a correct answer to a question may indicate the attendee remains at the in-person event.

In some embodiments, interface module 205 may broadcast one or more question prompts to each mobile device that joins the in-person event. In some cases, interface module 205 may determine whether a response is a correct answer. In some cases, interface module 205 may provide feedback indicating whether the answer provided is correct. In some cases, the interface module 205 may request that the attendee watch a video when the answers fail to satisfy an answer threshold. In some cases, the answer threshold may be based on how many answers are correct. As one example, a question prompt may include 10 questions and 6 or more correct answers out of the 10 questions may satisfy the answer threshold. Additionally or alternatively, the answer threshold may be based on a correct percentage of answers such as when 60% or more of all questions asked are answered correctly satisfies the answer threshold.

In some cases, the presenter and/or administrator of the in-person event may indicate an end of the in-person event. As one example, a presenter may select an “end” button to end the in-person event. In some cases, when the interface module 205 identifies the end of the in-person event, the interface module 205 may send an ending prompt to one or more mobile devices that joined the in-person event. In some cases, the ending prompt may include one or more questions to be answered by the attendee. In some cases, intermediary and/or end-of-event prompts may also be accompanied by a location check of the mobile device.

In some embodiments, interface module 205 may be configured to schedule distribution of media content such as scheduling training videos in a certain order for distribution to one or more users based at least in part on predetermined work schedule of the one or more users. In one embodiment, the predetermined work schedule may include a set schedule such as Monday through Friday 9:00 AM to 5:00 PM. Additionally or alternatively, the predetermined work schedule may be based at least in part on determining a location of the employee in relation to a predetermined work location and/or. In some cases, interface module 205 may be configured to distribute at least one media file per work day to the one or more users based at least in part on the scheduled order of the media content. In some embodiments, interface module 205 may be configured to pause the schedule of the media content based at least in part on a pause request from at least one of the one or more users. In some cases, interface module 205 may be configured to automatically restart distribution of the one training video per workday based at least in part on an end date designated in the pause request. In some cases, the pause request may include a start date and an end date.

In some embodiments, interface module 205 may be configured to schedule media content in a certain order for distribution to one or more users based at least in part on predetermined workdays of the one or more users. In some embodiments, interface module 205 may be configured to distribute one training video per workday to the one or more users based at least in part on the scheduled order of the media content. In some embodiments, analysis module 215 may be configured to identify a user from the one or more users not watching a certain training video on a day the certain training video was distributed to the user. In some embodiments, interface module 205 may be configured to send a warning message to a mobile device associated with the user. In some cases, the warning message may indicate a deadline by which time the user may watch the video without incurring a penalty. In the case where the user fails to watch the video by the specified deadline, the user may receive a predetermined penalty associated with the training and compliance of the user. In some cases, the penalty may include a written warning that is saved to the user's file that may be used in assessing a user's performance and/or compliance, etc.

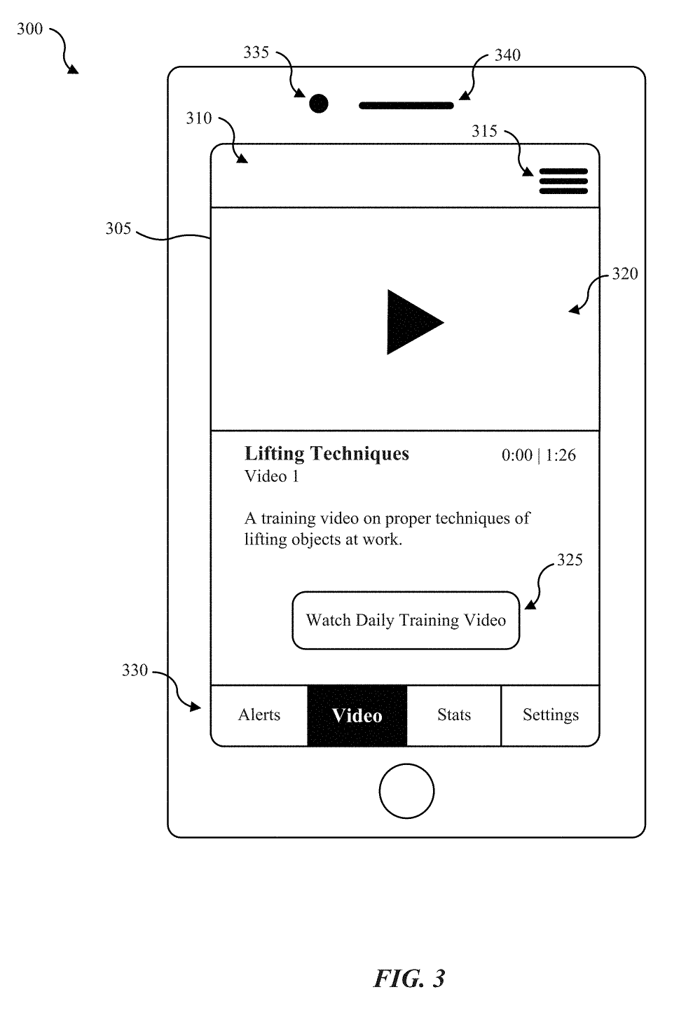

FIG. 3 is a sample interface illustrating one example of mobile device 300 for improving safety and training compliance. In some configurations, the environment 300 may be implemented by the safety rating module 145 illustrated in FIGS. 1 and/or 2. In some configurations, the environment 300 may be implemented in conjunction with device 105, server 110, network 115, database 120, components thereof, or any combination thereof.

As depicted, device 300 may include a screen 305. As illustrated, screen 305 displays a user interface of the present systems and methods. In some cases, screen 305 of device 300 may display a user interface that enables a user to watch scheduled videos. Although referring to videos with regards to the example embodiment of FIG. 3, it is understood that additionally or alternatively other types of media files may be used such as audio files, image files, book files, or any combination thereof.

As depicted, the screen 305 may display a notification area 310 where notifications may be displayed. For example, video notifications may be displayed in notification area 310. In some cases, screen 305 may display a menu option button 315. In some cases, the menu option button 315 may enable a user to select from one or more options in a drop down menu after the user taps or selects the menu option button 315. In some cases, menu option button 315 may be part of the user interface displayed on screen 305.

In one embodiment, screen 305 may display a video 320. As illustrated, the video 320 may include one or more controls such as a play button, pause button, fast forward button, rewind button, exit button, or any combination thereof. As shown, screen 305 may display a training video related to safe lifting techniques. In some cases, the user interface displayed on screen 305 may include a watch button 325. When a user taps or selects the watch button 325 the video may begin. In some cases, upon finishing the video, a log may be updated indicating the user watched the video.

In some cases, the user interface displayed on screen 305 may include one or more interface buttons 330. The interface buttons 330 may enable a user to browse the different sections of the user interface. For example, the interface buttons 330 may include an alerts button to view an alert section, a video button to view a video section, a stats button to view a statistics section, a settings button to view a settings section, etc. In some cases, the device 300 may include a front facing camera 335 and at least one speaker 340 to enable at least some ways the user may interact with the user interface.

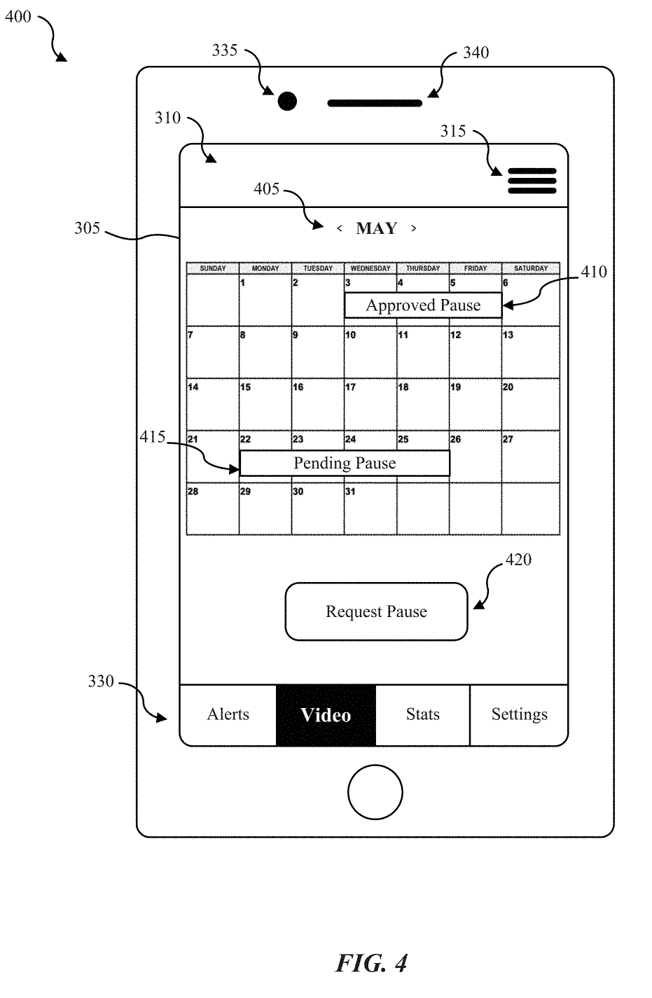

FIG. 4 is a sample interface illustrating one example of device 400 for improving safety and training compliance. In some configurations, the environment 400 may be implemented by the safety rating module 145 illustrated in FIGS. 1 and/or 2. In some configurations, the environment 400 may be implemented in conjunction with device 105, server 110, network 115, database 120, components thereof, or any combination thereof.

As depicted, device 400 may include one or more elements and/or components of device 300 from FIG. 3, such as screen 305, notification area 310, etc. In some cases, device 400 may display a user interface related to the user interface displayed on device 300. In some cases, screen 305 of device 400 may display a user interface that enables a user to request pause periods and/or view approved pause periods. As shown, the user interface displayed on screen 305 of device 400 may include a calendar 405. The user may select a month by pressing arrow buttons “<” or “>” or the name of the month “MAY” as shown in the user interface displayed on device 300. In some embodiments, the calendar 405 may show pause requests and/or approved pauses. As shown, calendar 405 may display an approved pause 410. The approved pause 410 may indicate a pause period when the system does not send video notifications to the user and/or does not track whether the user watches a video. As illustrated, calendar 405 may also display a pending pause 415. The pending pause 415 may indicate a pause period that the user is requesting to be approved by an administrator. Once approved, the calendar 405 may convert the pending pause 415 to an approved pause for the indicated period.

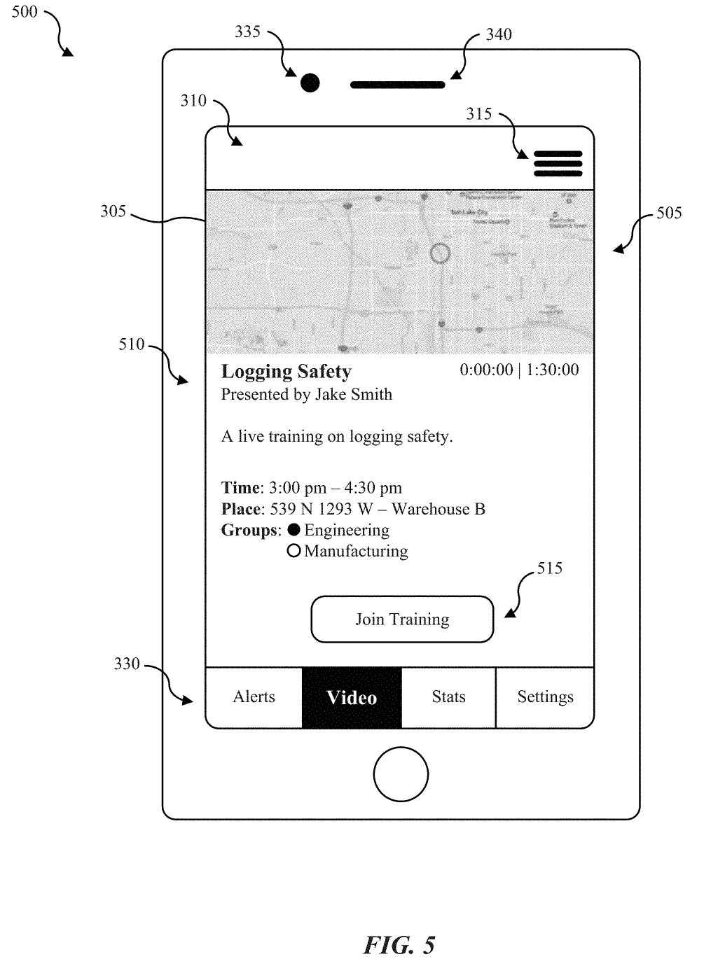

FIG. 5 is a sample interface illustrating one example of device 500 for improving safety and training compliance. In some configurations, the environment 500 may be implemented by the safety rating module 145 illustrated in FIGS. 1 and/or 2. In some configurations, the environment 500 may be implemented in conjunction with device 105, server 110, network 115, database 120, components thereof, or any combination thereof.

As depicted, device 500 may include one or more elements and/or components of device 300 from FIG. 3 and/or device 400 from FIG. 4, such as screen 305, notification area 310, etc. In some cases, device 500 may display a user interface related to the user interface displayed on device 300 and/or device 400. In some cases, screen 305 of device 300 may display a user interface that enables a user to attend an in-person event. As shown, the user interface displayed on screen 305 of device 500 may include a map 505. In some cases, the map 505 may be associated with an in person training event. In some embodiments, the user interface displayed on screen 305 of device 500 may include one or more details 510 of the in person training event. For example, the details 510 of the in-person event may include at least one of an event title, a presenter of the in-person event, an event length, a description of the in-person event, a start time of the in-person event, an end time of the in-person event, a location of the in-person event, and one or more employees and/or work groups assigned to the in-person event, or any combination thereof. In some cases, the user interface displayed on screen 305 of device 500 may include a join button 515. Although not depicted, in some cases, the user interface displayed on screen 305 of device 500 may include a decline button. In some embodiments, an attendee of the in-person event may tap or select the join button 515 to join the in-person event and/or get credit for attending the in-person event.

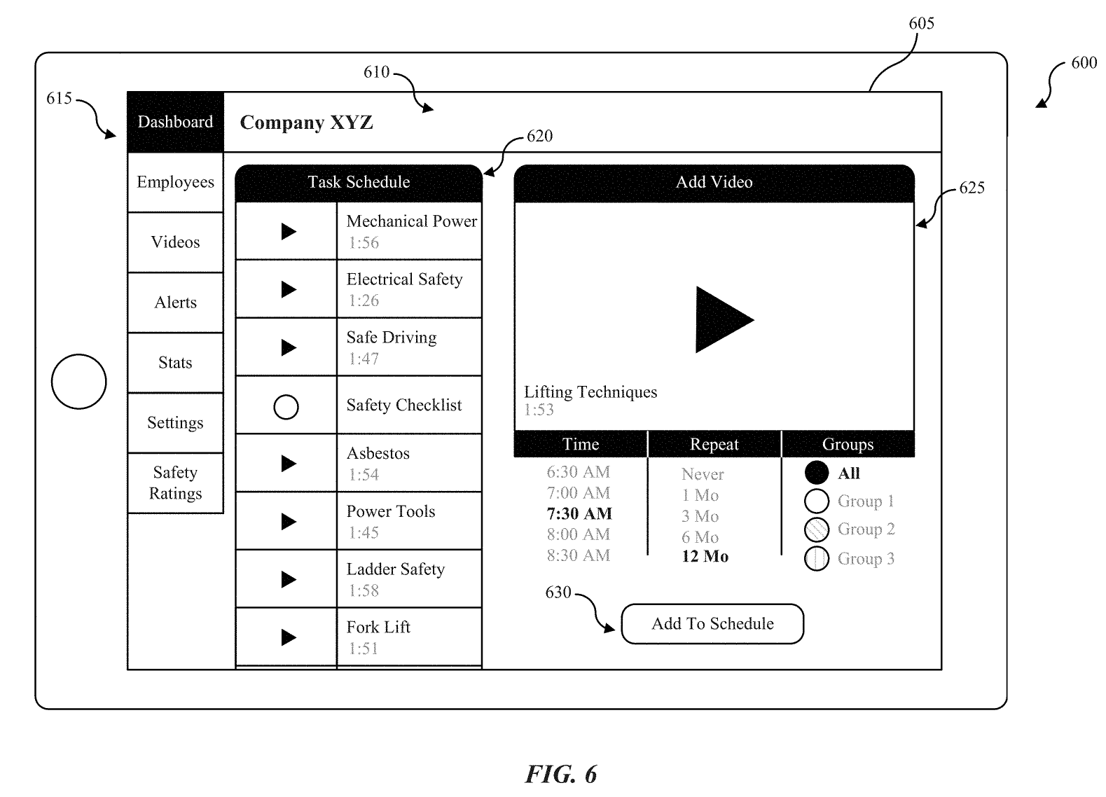

FIG. 6 is a sample interface illustrating one example of device 600 for improving safety and training compliance. In some configurations, the environment 600 may be implemented by the safety rating module 145 illustrated in FIGS. 1 and/or 2. In some configurations, the environment 600 may be implemented in conjunction with device 105, server 110, network 115, database 120, components thereof, or any combination thereof.

As depicted, device 600 may include a screen 605. A user interface of device 600 may include a notification area 610, and one or more interface buttons 615. In some cases, screen 605 of device 600 may display a user interface that enables an administrator to add a new video to a list of scheduled videos. Although referring to videos with regards to the example embodiment of FIG. 6, it is understood that additionally or alternatively other types of media files may be used such as audio files, image files, book files, or any combination thereof.

In one embodiment, the user interface displayed on screen 605 may include user interface for administrators of the present systems and methods while the user interface displayed on screen 305 of device 300, 400, and/or 500 may include a user interface for general users of the present systems and methods. As shown, interface buttons 615 may enable a user to browse the different sections of the user interface. For example, the interface buttons 615 may include dashboard button to view a dashboard section, an employee button to view an employee section, a video button to view a video section, an alerts button to view alerts, a stats button to view statistics, a settings button to configure settings, a safety ratings button to view safety ratings of a person and/or safety ratings of an entity, etc.

In some embodiments, the user interface displayed on screen 605 may include a task schedule 620. The task schedule 620 may appear daily, every other day, weekly, monthly, annually, on work days only, on certain work days only, only on certain scheduled days, or at any other configured schedule. The task schedule 620 may include a list of one or more videos in a particular sequence. In some cases, notifications for the videos may be sent based on the particular sequence. For example, a first video may be on mechanical power, a second video on electrical safety, etc. In some cases, the first video may be scheduled for a first day, the second video for a second day, etc. Accordingly, a first notification for the mechanical power video may be sent on the first day, a notification for the electrical safety video may be sent on the second day, and so on. The task schedule 620 may also include pre-work checklists configured to enable a person to go through and verify that a certain checklist has been followed. For example, a pre-work checklist may include multiple steps to check that a safety protocol is adhered to. In some cases, the pre-work checklist may include questions asking whether a certain item on the list has been performed or checked. For example, the question may ask whether steel-toed boots are being worn, whether a hard hat is being worn, whether equipment has been tested, whether a certification on equipment has been checked and hasn't expired, whether a vehicle has been inspected. In some cases, a pre-work checklist may include a start date and an end date. For example, a pre-work checklist may appear on a person's dashboard only on or between a specified start date and an end date.

In some examples, a pre-work checklist may be assigned to a certain person and/or a certain group of persons, where the pre-work checklist shows up only on the dashboards of those persons assigned to the pre-work checklist. In some cases, a pre-work checklist may include an ADD PHOTO button that enables a user to upload a photo as an indication that a task on the pre-work checklist has been performed. In some embodiments, a new version of the pre-work checklist may be created each time the pre-work checklist is augmented or modified. In some cases, each version of the pre-work checklist may be saved in a database (e.g., database 120). In some embodiments, a report of the pre-work checklist may be generated indicating answers to items on the pre-work checklist on a given day or over a given time period (e.g., answers provided over the last week, etc.). In some cases, a report of the pre-work checklist may indicate which persons have completed and which persons have not completed the pre-work checklist on a certain day or over a certain time period.

In some cases, a person's compliance with the task schedule 620 (e.g., watching videos, taking quizzes, quiz scores, performing checklists, frequency of watching videos, frequency of performing checklists, etc.) may affect a safety rating of the person (e.g., improve a safety rating based on meeting at least a predetermined baseline performance, or worsen a safety rating based on failing to meet at least a predetermined baseline performance). In some cases, an infraction (e.g., an accident, failing to watch a video, failing to take a quiz, an unfavorable quiz score (e.g., below 70% questions answered correctly), failing to perform a checklist, an unfavorable risk assessment, etc.) may affect the safety rating based on the degree of the infraction. For example, certain infractions may be weighted greater than other infractions. For instance, an accident may reduce a safety rating more than missing a quiz, etc. Additionally or alternatively, compliance actions (e.g., reporting an accident, reporting a safety or health violation, watching a safety video, a streak of watching videos, a frequency of watching videos, taking a quiz, a streak of taking quizzes, a frequency of taking quizzes, a favorable quiz score (e.g., 70% or greater questions answered correctly), performing a checklist, a streak of performed checklists, a frequency of performing checklists, adherence to company safety and/or training policies, a favorable risk assessment, etc.) may affect the safety rating based on the degree of the compliance. For example, certain compliance actions may be weighted greater than other compliance actions. For instance, reporting a safety violation may increase a safety rating more than watching a single safety video, etc. In some cases, the safety rating of a person may in turn affect the safety rating of an associated organization.

In some embodiments, the user interface displayed on screen 605 may include an add video option 625. The add video option 625 may enable an administrator to select a video to add to the task schedule 620. In some cases, the administrator may add the video anywhere in the sequence of videos in the task schedule 620 such as between the first and second videos, etc. In some cases, the add video option 625 may include at least one of a scheduled time such as a time of day (e.g., 7:30 AM), a repeat option (e.g., repeat the video every 12 months), and one or more groups which may be assigned to watch the video as scheduled, or any combination thereof. In some embodiments, the user interface displayed on screen 605 may include an add video button 630 that enables the administrator to add the video anywhere in the sequence of videos in the task schedule 620. In some cases, an administrator may drag and drop the new video anywhere in the sequence of videos in the task schedule 620.

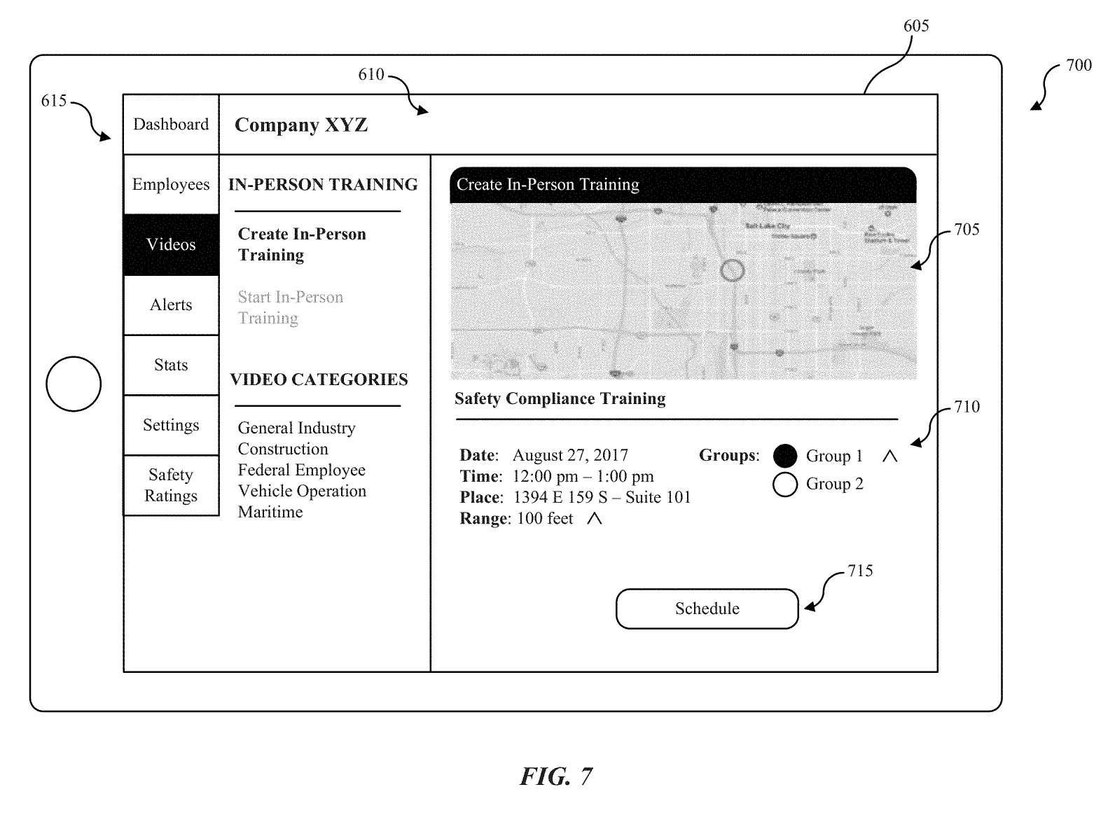

FIG. 7 is a sample interface illustrating one example of device 700 for improving safety and training compliance. In some configurations, the device 700 may be implemented by the safety rating module 145 illustrated in FIGS. 1 and/or 2. In some configurations, the device 700 may be implemented in conjunction with device 105, server 110, network 115, database 120, components thereof, or any combination thereof.

As depicted, device 700 may include one or more elements and/or components of device 600 from FIG. 6, such as screen 605, notification area 610, etc. In some cases, device 700 may display a user interface related to the user interface displayed on device 600. In some cases, screen 605 of device 700 may display a user interface that enables an administrator to create an in-person event.

As shown, the user interface displayed on screen 605 of device 700 may include a map 705 associated with an in-person event being created by an administrator and/or presenter of the in-person event. In some embodiments, the user interface displayed on screen 605 of device 700 may include details 710 regarding the in-person event being created. In some cases, the details 710 of the in-person event being created may include at least one of a date of the in-person event, a start time of the in-person event, an end time of the in-person event, a location of the in-person event, a range threshold of the in-person event, and one or more employees and/or work groups assigned to the in-person event, or any combination thereof. In some embodiments, the details 710 may include one or more drop down menus that enable the administrator to select any particular detail of the in-person event such as the range threshold, the assigned work groups, etc.

In some embodiments, the user interface displayed on screen 605 of device 700 may include a schedule button 715 that enables the administrator to schedule the in-person event. In some cases, adding a work group to an in-person event and selecting the schedule button 715 may result in each member of that work group receiving a notification regarding the in-person event. In some cases, each member of the work group may receive an invitation to attend the in-person event. Additionally or alternatively, a member of the work group that has not yet registered for the in-person event may receive an invitation to register for the in-person event.

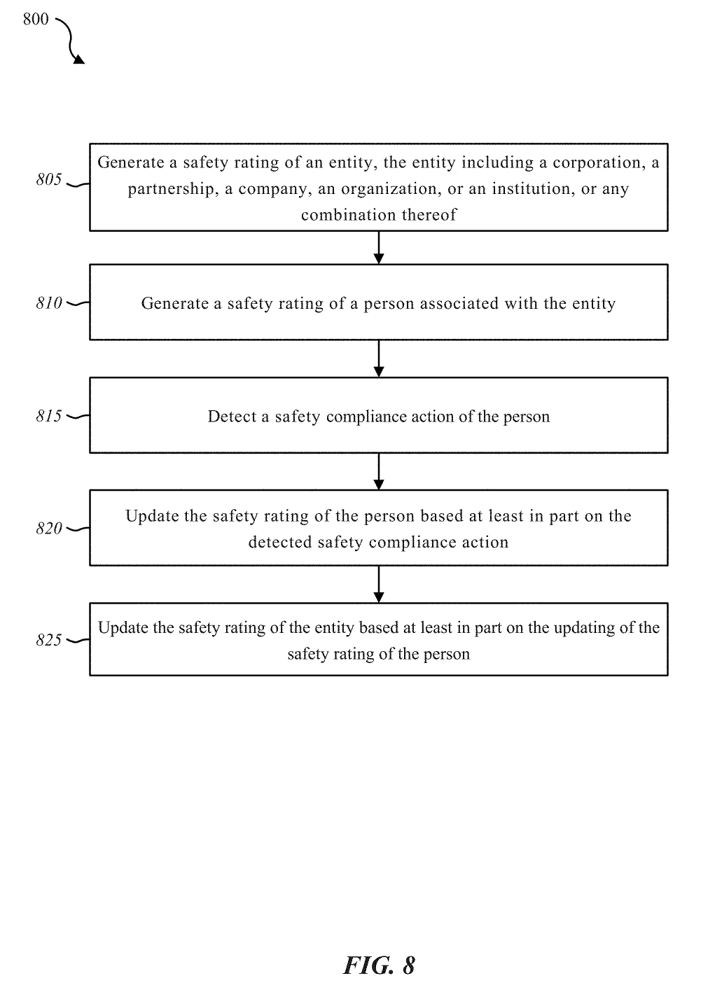

FIG. 8 is a flow diagram illustrating one embodiment of a method 800 for improving safety and training compliance. In some configurations, the method 800 may be implemented by the safety rating module 145 illustrated in FIGS. 1 and/or 2. In some configurations, the method 800 may be implemented in conjunction with device 105, server 110, network 115, database 120, components thereof, or any combination thereof.

At block 805, method 800 may include generating a safety rating of an entity, the entity including a corporation, a partnership, a company, an organization, or an institution, or any combination thereof. At block 810, method 800 may include generating a safety rating of a person associated with the entity. At block 815, method 800 may include detecting a safety compliance action of the person. A safety compliance action of the person may include the person reading a safety and/or health policy of an entity, verifying the person read the policy, the person watching a safety training video, the person attending a live safety training, the person taking a safety training quiz, the person passing a safety training quiz, the person reporting an incident related to safety condition and/or health condition, the person taking a picture of the incident, the person posting the report of the incident and/or information related to the incident, or any combination thereof. At block 820, method 800 may include updating the safety rating of the person based at least in part on the detected safety compliance action.

At block 825, method 800 may include updating the safety rating of the entity based at least in part on the updating of the safety rating of the person. For example, method 800 lowering/raising the safety rating of the person may result in method 800 lowering/raising the safety rating of the entity by a predetermined factor that depends on the degree to which the safety rating of the person was lowered/raised. In some cases, a third party may adjust a credit rating of the entity as a result of the real time adjustment of the safety rating of the company. For example, a lowering of the safety rating of the entity may result in the third party lowering a credit rating of the entity. In some cases, method 800 may include performing one or more operations in conjunction with one or more processors of a computing device and/or a mobile computing device.

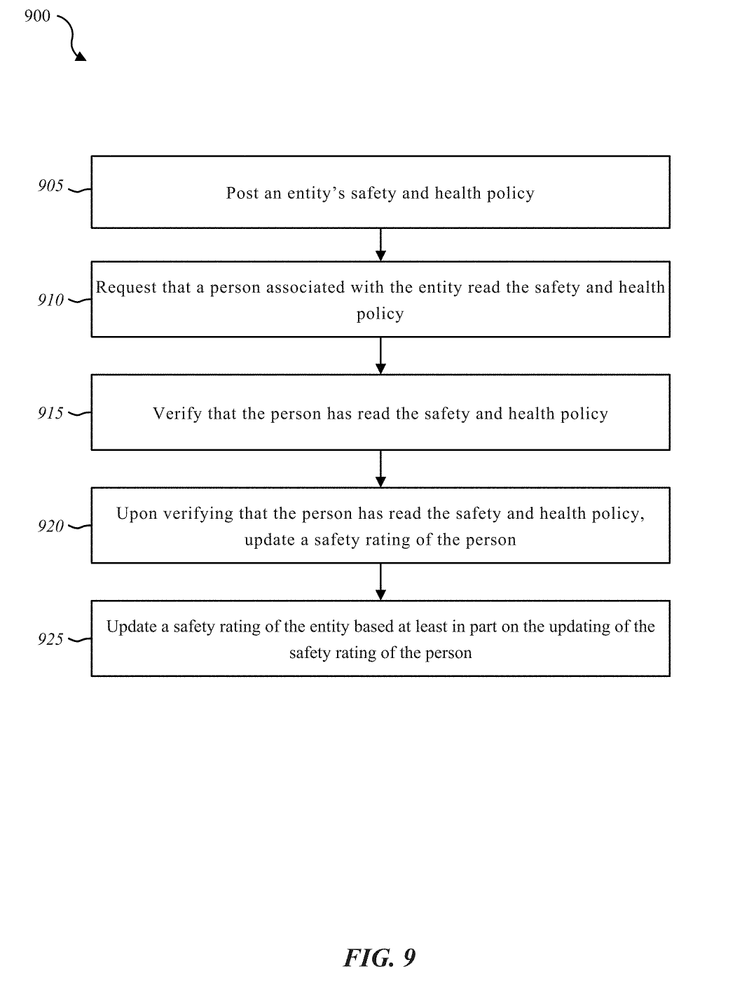

FIG. 9 is a flow diagram illustrating one embodiment of a method 900 for improving safety and training compliance. In some configurations, the method 900 may be implemented by the safety rating module 145 illustrated in FIG. 1 or 2. In some configurations, the method 900 may be implemented in conjunction with device 105, server 110, network 115, database 120, components thereof, or any combination thereof.

At block 905, method 900 may include posting an entity's safety and health policy. The method 900 may include posting the safety and health policy on at least one of a publically available website, an employee accessible website, a mobile application executing on the mobile computing device, or any combination thereof.

At block 910, method 900 may include requesting that the person read the safety and health policy. The request may include sending the request in at least one of a text message, an email, a recorded phone call, or any combination thereof.

At block 915, method 900 may include verifying that the person has read the safety and health policy. In some cases, verifying that the person has read the safety and health policy may include posting on a computing device one or more questions, content from the questions being based at least in part on content from the safety and health policy, and determining whether the person provides correct answers to the one or more questions.

At block 920, method 900 may include updating a safety rating of the person upon verifying that the person has read the safety and health policy.

At block 925, method 900 may include updating the safety rating of the entity based at least in part on the updating of the safety rating of the person. For example, method 900 lowering/raising the safety rating of the person may result in method 900 lowering/raising the safety rating of the entity by a predetermined factor that depends on the degree to which the safety rating of the person was lowered/raised.

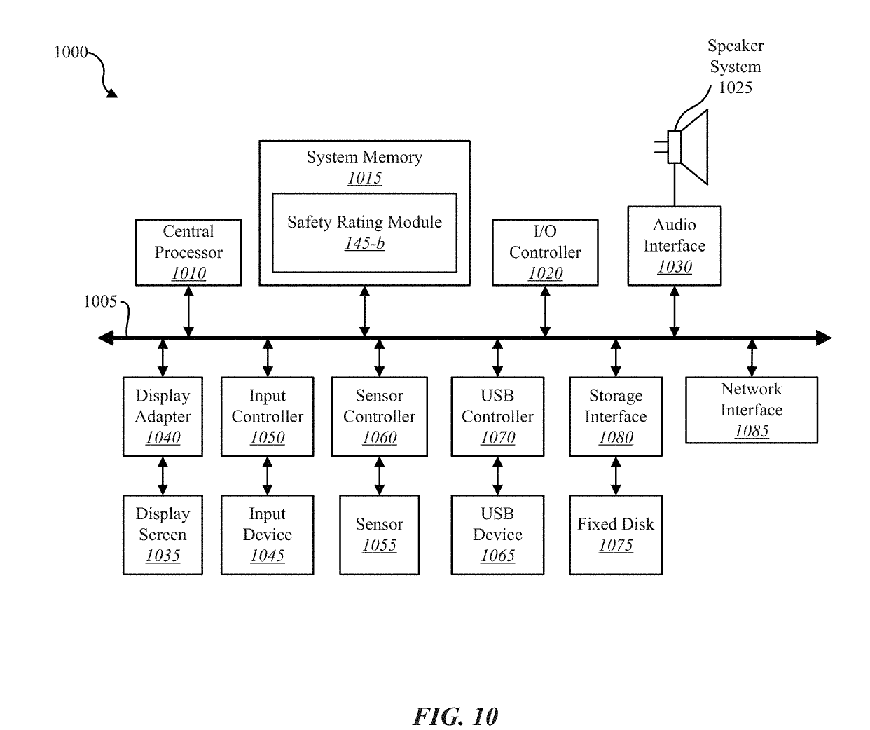

FIG. 10 depicts a block diagram of a computing device 1000 suitable for implementing the present systems and methods. The device 1000 may be an example of device 105, computing device 150, and/or server 110 illustrated in FIG. 1. In one configuration, device 1000 includes a bus 1005 which interconnects major subsystems of device 1000, such as a central processor 1010, a system memory 1015 (typically RAM, but which may also include ROM, flash RAM, or the like), an input/output controller 1020, an external audio device, such as a speaker system 1025 via an audio output interface 1030, an external device, such as a display screen 1035 via display adapter 1040, an input device 1045 (e.g., remote control device interfaced with an input controller 1050), multiple USB devices 1065 (interfaced with a USB controller 1070), and a storage interface 1080. Also included are at least one sensor 1055 connected to bus 1005 through a sensor controller 1060 and a network interface 1085 (coupled directly to bus 1005).

Bus 1005 allows data communication between central processor 1010 and system memory 1015, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components or devices. For example, the safety rating module 145-b to implement the present systems and methods may be stored within the system memory 1015. Applications (e.g., application 140) resident with device 1000 are generally stored on and accessed via a non-transitory computer readable medium, such as a hard disk drive (e.g., fixed disk 1075) or other storage medium. Additionally, applications can be in the form of electronic signals modulated in accordance with the application and data communication technology when accessed via interface 1085.

Storage interface 1080, as with the other storage interfaces of device 1000, can connect to a standard computer readable medium for storage and/or retrieval of information, such as a fixed disk drive 1075. Fixed disk drive 1075 may be a part of device 1000 or may be separate and accessed through other interface systems. Network interface 1085 may provide a direct connection to a remote server via a direct network link to the Internet via a POP (point of presence). Network interface 1085 may provide such connection using wireless techniques, including digital cellular telephone connection, Cellular Digital Packet Data (CDPD) connection, digital satellite data connection, or the like. In some embodiments, one or more sensors (e.g., motion sensor, smoke sensor, glass break sensor, door sensor, window sensor, carbon monoxide sensor, and the like) connect to device 1000 wirelessly via network interface 1085.

Many other devices and/or subsystems may be connected in a similar manner (e.g., entertainment system, computing device, remote cameras, wireless key fob, wall mounted user interface device, cell radio module, battery, alarm siren, door lock, lighting system, thermostat, home appliance monitor, utility equipment monitor, and so on). Conversely, all of the devices shown in FIG. 10 need not be present to practice the present systems and methods. The devices and subsystems can be interconnected in different ways from that shown in FIG. 10. The aspect of some operations of a system such as that shown in FIG. 10 are readily known in the art and are not discussed in detail in this application. Code to implement the present disclosure can be stored in a non-transitory computer-readable medium such as one or more of system memory 1015 or fixed disk 1075. The operating system provided on device 1000 may be iOS®, ANDROID®, MS-DOS®, MS-WINDOWS®, OS/2®, UNIX®, LINUX®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present systems and methods may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The signals associated with system 1000 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network interface 1085 may enable one or more of WWAN (GSM, CDMA, and WCDMA), WLAN (including BLUETOOTH® and Wi-Fi), WMAN (WiMAX) for mobile communications, antennas for Wireless Personal Area Network (WPAN) applications (including RFID and UWB), etc.

The I/O controller 1020 may operate in conjunction with network interface 1085 and/or storage interface 1080. The network interface 1085 may enable system 1000 with the ability to communicate with client devices (e.g., device 105 of FIG. 1), and/or other devices over the network 115 of FIG. 1. Network interface 1085 may provide wired and/or wireless network connections. In some cases, network interface 1085 may include an Ethernet adapter or Fibre Channel adapter. Storage interface 1080 may enable system 1000 to access one or more data storage devices. The one or more data storage devices may include two or more data tiers each. The storage interface 1080 may include one or more of an Ethernet adapter, a Fibre Channel adapter, Fibre Channel Protocol (FCP) adapter, a SCSI adapter, and iSCSI protocol adapter.

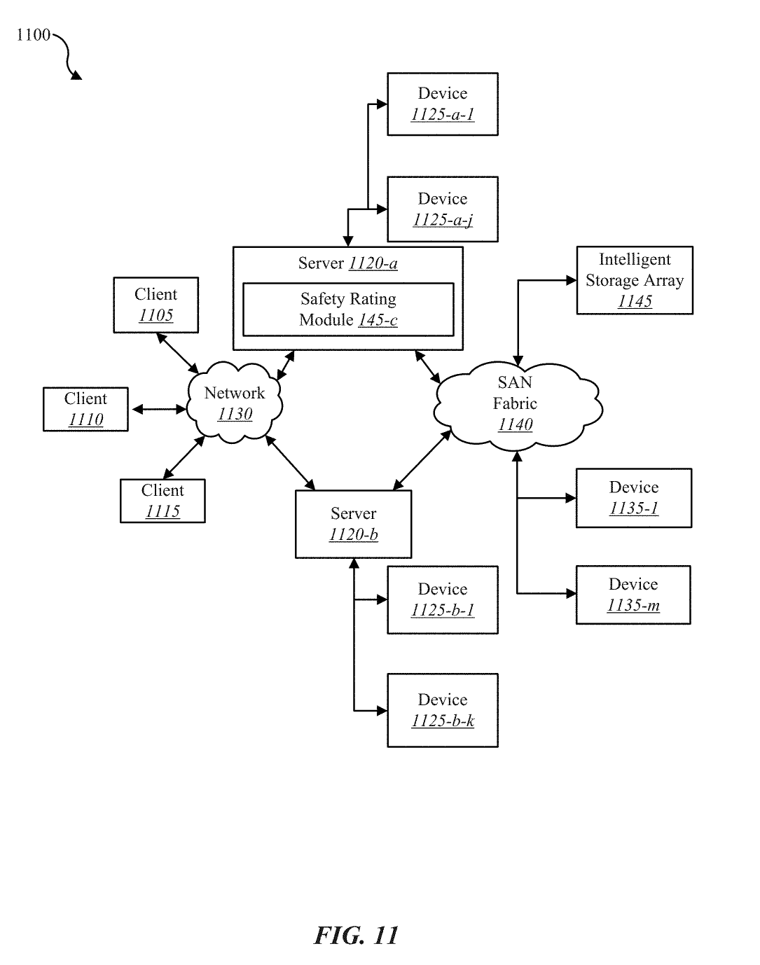

FIG. 11 is a block diagram depicting a network architecture 1100 in which client systems 1105, 1110 and 1115, as well as storage servers 1120-a and 1120-b (any of which can be implemented using computer system 600), are coupled to a network 1130. In one embodiment, safety rating module 145-c may be located within one of the storage servers 1120-a, 1120-b to implement the present systems and methods. Safety rating module 145-c may be one example of safety rating module 145 depicted in FIGS. 1, 2, and/or 6. The storage server 1120-a is further depicted as having storage devices 1125-a-1 through 1125-a-j directly attached, and storage server 1120-b is depicted with storage devices 1125-b-1 through 1125-b-k directly attached. SAN fabric 1140 supports access to storage devices 1135-1 through 1135-m by storage servers 1120-a and 1120-b, and so by client systems 1105, 1110 and 1115 via network 1130. Intelligent storage array 1145 is also shown as an example of a specific storage device accessible via SAN fabric 1140.

With reference to computer system 600, network interface 685 or some other method can be used to provide connectivity from each of client computer systems 1105, 1110 and 1115 to network 1130. Client systems 1105, 1110 and 1115 are able to access information on storage server 1120-a or 1120-b using, for example, a web browser or other client software (not shown). Such a client allows client systems 1105, 1110 and 1115 to access data hosted by storage server 1120-a or 1120-b or one of storage devices 1125-a-1 to 1125-a-j, 1125-b-1 to 1125-b-k, 1135-1 to 1135-m or intelligent storage array 1145. FIG. 11 depicts the use of a network such as the Internet for exchanging data, but the present systems and methods are not limited to the Internet or any particular network-based environment.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A method for a safety rating system, comprising:
generating, by a processer of a mobile computing device, a safety rating of an entity, the entity including a corporation, a partnership, a company, an organization, or an institution, or any combination thereof;
generating, by the processor, a safety rating of a person associated with the entity;
detecting, by the processor, a safety compliance action of the person;
updating, by the processor, the safety rating of the person based at least in part on the detected safety compliance action; and
updating, by the processor, the safety rating of the entity based at least in part on the updating of the safety rating of the person.

2. The method of claim 1, further comprising:
posting the entity's safety and health policy on a publically available website, on an employee accessible website, on a mobile application executing on the mobile computing device, or any combination thereof.

3. The method of claim 2, further comprising:
requesting that the person read the safety and health policy;
verifying that the person has read the safety and health policy; and
upon verifying that the person has read the safety and health policy, updating the safety rating of the person.

4. The method of claim 3, wherein verifying that the person has read the safety and health policy includes posting on a mobile computing device of the user via a mobile application one or more questions, content from the questions being based at least in part on content from the safety and health policy, and determining whether the person provides correct answers to the one or more questions.

5. The method of claim 1, further comprising:
providing, in a mobile application, a reporting system to enable the person to report conditions associated with the entity;
receiving via the reporting system a report of a current condition provided by the person; and
updating the rating of the person based at least in part on the person providing the report.

6. The method of claim 5, wherein the conditions reported under the reporting system include hazardous conditions, safety conditions, environmental conditions, or health conditions, or any combination thereof.

7. The method of claim 5, further comprising:
enabling, via the reporting system, the person to take one or more pictures of the current condition and to add the one or more pictures to the report, wherein the reporting system automatically stores the one or more pictures in local storage associated with the mobile application, on a central server, in cloud storage, or in any combination thereof.

8. The method of claim 5, further comprising:
identifying keywords associated with the current condition;
selecting one or more administrators based at least in part on the identified keywords; and
routing the report to the selected administrators.

9. The method of claim 1, further comprising:
providing safety training information to the person;
verifying the safety training information provided to the person; and
updating the rating of the person based at least in part on the verifying of the training information.

10. The method of claim 9, further comprising:
updating the rating of the person based at least in part on a safety training attendance associated with the person, a number of safety trainings taken by the person, a frequency of safety trainings taken by the person, a score of a safety training test taken by the person, multiple safety training scores associated with the person, or any combination thereof.

11. The method of claim 1, further comprising:
updating the rating of the entity in real time based at least in part on an updated rating of the person, wherein updating the rating of the entity or updating the rating of the person, or both, is performed automatically without human intervention.

12. A computing device configured for safety rating systems, comprising:
one or more processors of a mobile computing device;
memory in electronic communication with the one or more processors, wherein the memory stores computer executable instructions that when executed by the one or more processors cause the one or more processors to perform the steps of:
generating a safety rating of an entity, the entity including a corporation, a partnership, a company, an organization, or an institution, or any combination thereof;
generating a safety rating of a person associated with the entity;
detecting a safety compliance action of the person;
updating the safety rating of the person based at least in part on the detected safety compliance action; and
updating the safety rating of the entity based at least in part on the updating of the safety rating of the person.

13. The computing device of claim 12, wherein the instructions executed by the one or more processors cause the one or more processors to perform the steps of:
posting the entity's safety and health policy on a publically available website, on an employee accessible website, on a mobile application executing on the mobile computing device, or any combination thereof.

14. The computing device of claim 13, wherein the instructions executed by the one or more processors cause the one or more processors to perform the steps of:
requesting that the person read the safety and health policy;
verifying that the person has read the safety and health policy; and
upon verifying that the person has read the safety and health policy, updating the safety rating of the person.

15. The computing device of claim 14, wherein verifying that the person has read the safety and health policy includes posting on a mobile computing device of the user via a mobile application one or more questions, content from the questions being based at least in part on content from the safety and health policy, and determining whether the person provides correct answers to the one or more questions.

16. The computing device of claim 12, wherein the instructions executed by the one or more processors cause the one or more processors to perform the steps of:
providing, in a mobile application, a reporting system to enable the person to report conditions associated with the entity;
receiving via the reporting system a report of a current condition provided by the person; and
updating the rating of the person based at least in part on the person providing the report.

17. The computing device of claim 16, wherein the conditions reported under the reporting system include hazardous conditions, safety conditions, or health conditions, or any combination thereof.

18. The computing device of claim 16, wherein the instructions executed by the one or more processors cause the one or more processors to perform the steps of:
enabling, via the reporting system, the person to take one or more pictures of the current condition and to add the one or more pictures to the report, wherein the reporting system automatically stores the one or more pictures in local storage associated with the mobile application, on a central server, in cloud storage, or in any combination thereof.

19. A computer-program product for safety rating systems, the computer-program product comprising a non-transitory computer-readable medium storing instructions thereon, the instructions being executable by one or more processor to perform the steps of:
generating a safety rating of an entity, the entity including a corporation, a partnership, a company, an organization, or an institution, or any combination thereof;
generating a safety rating of a person associated with the entity;
detecting a safety compliance action of the person;
updating the safety rating of the person based at least in part on the detected safety compliance action; and
updating the safety rating of the entity based at least in part on the updating of the safety rating of the person.

20. The computer-program product of claim 19, wherein the instructions executed by the one or more processors cause the one or more processors to perform the steps of:
posting the entity's safety and health policy on a publically available website, on an employee accessible website, on a mobile application executing on a mobile computing device, or any combination thereof;
requesting that the person read the safety and health policy;
verifying that the person has read the safety and health policy; and
upon verifying that the person has read the safety and health policy, updating the safety rating of the person.
